(19) United States
(12) Patent Application Publication
(10) Pub. No.: US 2023/0406994 A1
(43) Pub. Date: Dec. 21, 2023

(54) THERMOSETTING EPOXY RESIN COMPOSITION, MOLDED ARTICLE OF SAME, FIBER-REINFORCED COMPOSITE MATERIAL, MOLDING MATERIAL FOR FIBER-REINFORCED COMPOSITE MATERIALS, AND METHOD FOR PRODUCING FIBER-REINFORCED COMPOSITE MATERIAL

(71) Applicant: TORAY INDUSTRIES, INC., Tokyo (JP)

(72) Inventors: Ko MATSUKAWA, Nagoya-shi (JP); Daisuke KONISHI, Nagoya-shi (JP); Nobuyuki TOMIOKA, Nagoya-shi (JP)

(73) Assignee: TORAY INDUSTRIES, INC., Tokyo (JP)

(21) Appl. No.: 18/035,801

(22) PCT Filed: Nov. 2, 2021
(86) PCT No.: PCT/JP2021/040343

§ 371 Date: May 8, 2023

(30) Foreign Application Priority Data
Nov. 16, 2020 (JP) 2020-190056
Dec. 8, 2020 (JP) 2020-203124
Dec. 21, 2020 (JP) 2020-211051
Jul. 26, 2021 (JP) 2021-121227

(51) Int. Cl. C08G 18/58; C08G 18/71; C08K 7/06; C08K 3/04; C08J 5/04; C08K 7/14

(52) U.S. Cl. CPC C08G 18/58; C08G 18/71; C08K 7/06; C08K 3/04; C08J 5/042; C08J 5/043; C08K 7/14; C08J 2375/04; B29C 70/48

(57) ABSTRACT

The purpose of the present invention is to provide a thermosetting epoxy resin composition that is excellent in terms of both pot life and fast curability at low temperatures and also a molded article that is prepared by thermally curing the thermosetting epoxy resin composition and is excellent in terms of both wet heat resistance and toughness. In order to achieve the purpose, the thermosetting epoxy resin composition of the present invention includes the following components [a], [b], [c], and [d], wherein the stoichiometric ratio of [b] to [a] is in the range from 0.5 to 2.0:
[a] an epoxy resin;
[b] an isocyanate curing agent;
[c] a hydroxyl group capping agent;
[d] an epoxy curing catalyst.

### TECHNICAL FIELD

The present invention relates to a thermosetting epoxy resin composition, a molded article made from the same, a fiber-reinforced composite material, a molding material for fiber-reinforced composite material, and a method of producing a fiber-reinforced composite material.

### BACKGROUND ART

Thermosetting polyurethane resins are used as a raw material for painting materials, adhesives, foam materials, elastomers, and the like in various fields because thermosetting polyurethane resins can be cured quickly at low temperatures due to the high reaction activity between isocyanate monomers and alcohol monomers in the polyurethane resins and because cured products of thermosetting polyurethane resins have excellent flexibility and toughness. On the other hand, cured products of polyurethane resins have problems such as low heat resistance and low wet resistance, as well as polyurethane resins have a problem of short pot life. Various studies have been conducted to improve the problems, and the studies have indicated that these problems can be improved by further incorporation of an epoxy component as a monomer (Patent Literature 1, 2, and 3).

Patent Literature 1 indicates that a dehydrating agent can prevent thickening of a curing agent solution for an adhesive that containing a polyisocyanate and pyrophosphoric acid and intended for use in laminates when the dehydrating agent is blended in the curing agent.

Patent Literature 2 indicates that use of an imidazolium catalyst can allow for promotion of urethane formation reaction between isocyanate and alcohol and, additionally, oxazolidone cyclization reaction of the resulting urethane with epoxy to improve pot life and heat resistance.

Patent Literature 3 indicates that addition of an epoxy to isocyanate reacted preliminarily with a polyol at an equivalent ratio as small as 1/20 to ⅓ and use of a Lewis acid and base catalyst can allow for promotion of oxazolidone cyclization reaction to improve the pot life of a resin composition and the heat resistance of a cured product of the resin composition.

Epoxy resins, which are thermosetting resins, are liquid and easy to handle before curing and will not outgas while curing, shrink slightly when curing, and exhibit excellent heat resistance, weather resistance, stiffness, toughness, and the like after curing. By virtue of these properties described above, epoxy resins are widely used in painting materials, electrical and electronic materials, civil engineering and construction materials, adhesives, fiber-reinforced composite materials, and the like.

Epoxy resins are classified into several types depending on a curing agent used, and commonly used epoxy resins include the following resins: amine-cured epoxy resins, which are most commonly used type of epoxy resins and exhibit high mechanical properties; phenol-cured epoxy resins, which are often used in solid or powder form and have a long pot life and high wet heat resistance; acid anhydride-cured epoxy resins, which have a low viscosity and a long pot life; and the like. However, any of the curing agent systems failed to achieve both an improved pot life and fast curability at low temperatures of resin compositions, as well as failed to allow thermally cured products of the resin compositions to achieve both high wet heat resistance and excellent toughness. To deal with this problem, isocyanate-epoxy hybrid resins have been proposed. For example, Patent Literature 4 indicates that a cured resin with a long pot life can be obtained in a short period of curing time by using a specific type of catalyst for the reaction between epoxy and isocyanate.

### CITATION LIST

### Patent Literature

Patent Literature 1: JP 2008-222983 A
Patent Literature 2: WO 2016/102358
Patent Literature 3: WO 2019/046382
Patent Literature 4: WO 2014/184082

### SUMMARY OF INVENTION

### Technical Problem

The polyurethane resin compositions described in Patent Literature 1 provide a curing agent solution with improved pot life, but the pot life of the resin compositions at high temperatures is still inadequate. Moreover, the polyurethane resin compositions have a problem with wet heat resistance due to the presence of the urethane structure and are therefore not available for a wide range of applications.

The polyurethane resin compositions described in Patent Literature 2 have an improved pot life at normal temperatures, but the pot life of the resin compositions is very shot at high temperatures. Moreover, the polyurethane resin compositions have a problem with wet heat resistance due to the presence of the urethane structure and are therefore not available for a wide range of applications.

The polyurethane resin compositions described in Patent Literature 3 have an improved pot life but still have difficulty in achieving both improved pot life and fast curability at low temperatures. Moreover, the presence of a large excess of isocyanate results in formation of many isocyanurate rings, which cause production of brittle cured products, and the polyurethane resin compositions are therefore not available for a wide range of applications.

The isocyanate-epoxy hybrid resin compositions described in Patent Literature 4 have an improved pot life at normal temperatures, but the pot life of the resin compositions is still short at high temperatures. Additionally, a side reaction occurs and generates a brittle cross-linked network structure and consequently causes cured products of the isocyanate-epoxy hybrid resin compositions to have a problem with toughness, and the isocyanate-epoxy hybrid resin compositions are therefore not available for a wide range of applications.

An object of the present invention is to improve the short points of the above conventional technologies and thereby provide a thermosetting epoxy resin composition that is excellent in terms of both pot life and fast curability at low temperatures and also a molded article that is prepared by thermally curing the thermosetting epoxy resin composition and is excellent in terms of both wet heat resistance and toughness. A further object of the present invention is to provide a fiber-reinforced composite material comprising the molded article in combination with a reinforcing fiber, a molding material for fiber-reinforced composite material, and a method of producing a fiber-reinforced composite material.

### Solution to Problem

To achieve the above objects, the present invention includes a thermosetting epoxy resin composition comprising the following components [a], [b], [c], and [d], wherein the stoichiometric ratio of [b] to [a] is in the range from 0.5 to 2.0:
[a] an epoxy resin;
[b] an isocyanate curing agent;
[c] a hydroxyl group capping agent;
[d] an epoxy curing catalyst.

Moreover, the present invention includes a molded article prepared by thermally curing the thermosetting epoxy resin composition and a fiber-reinforced composite material comprising the molded article and a reinforcing fiber.

Furthermore, the present invention includes a molding material for fiber-reinforced composite material, the molding material comprising the thermosetting epoxy resin composition and a reinforcing fiber, and a fiber-reinforced composite material prepared by thermally curing the molding material.

Additionally, the present invention includes a method of producing a fiber-reinforced composite material, the method comprising impregnating reinforcing fibers with the thermosetting epoxy resin and then curing the thermosetting epoxy resin by heat, and another method of producing a fiber-reinforced composite material, the method comprising placing a woven fabric composed primarily of reinforcing fibers into a mold, injecting the thermosetting epoxy resin composition into the mold for impregnation, and then curing the thermosetting epoxy resin composition by heat.

### Advantageous Effects of Invention

The present invention can provide a thermosetting epoxy resin composition that is excellent in terms of both pot life and fast curability at low temperatures and also a molded article that is prepared by thermally curing the thermosetting epoxy resin composition and is excellent in terms of both wet heat resistance and toughness.

### DESCRIPTION OF EMBODIMENTS

A thermosetting epoxy resin composition (hereinafter sometimes simply referred to as “epoxy resin composition”) according to the present invention and a molded article from the epoxy resin composition will be described below in details.

The thermosetting epoxy resin composition of the invention comprises the following components [a], [b], [c], and [d], wherein the stoichiometric ratio [b]/[a] of the component [b] to the component [a] is in the range from 0.5 to 2.0:
[a] an epoxy resin;
[b] an isocyanate curing agent;
[c] a hydroxyl group capping agent;
[d] an epoxy curing catalyst.

In the present invention, the component [a] is an epoxy resin. The epoxy resin is not limited to a specific epoxy resin as long as the epoxy resin is a compound containing an oxirane group in the molecule, but a compound containing at least two oxirane groups in the molecule is preferred. The presence of such a structure allows further increase of heat resistance and toughness in a molded article. Among others, an epoxy resin having a number average molecular weight in the range from 200 to 800 and containing aromatic groups in the backbone is preferable for use as the component [a] because such an epoxy resin provides an epoxy resin composition with low viscosity and excellent impregnating property into reinforcing fibers and because a fiber-reinforced composite material from the epoxy resin composition has excellent mechanical properties, such as heat resistance and elastic modulus. The number average molecular weight of an epoxy resin is determined by GPC (Gel Permeation Chromatography) using, for example, a polystyrene standard sample. For an epoxy resin with a known epoxy equivalent weight, a value calculated from the product of the epoxy equivalent weight and the number of epoxy functional groups can be used.

Epoxy resins used in the present invention are bisphenol type epoxy resins, amine-type epoxy resins, and the like.

The bisphenol type epoxy resins used in the present invention include, for example, bisphenol A-type epoxy resins, bisphenol F-type epoxy resins, bisphenol AD-type epoxy resins, and halogenated, alkylated, and hydrogenated derivatives thereof. Among others, bisphenol F-type epoxy resins are suitable for use because this type of epoxy resins are well-balanced with respect to high elastic modulus and high toughness. Specific examples of the epoxy resins are described below.

As bisphenol A-type epoxy resins, commercial products, such as “jER (registered trademark)” 825, “jER (registered trademark)” 827, “jER (registered trademark)” 828 (all manufactured by Mitsubishi Chemical Co.), “EPICLON (registered trademark)” 840, “EPICLON (registered trademark)” 850 (all manufactured by DIC Co.), “Epotohto (registered trademark)” YD-128, “Epotohto (registered trademark)” YD-8125, “Epotohto (registered trademark)” YD-825GS (all manufactured by Nippon Steel Chemical & Material Co., Ltd.), “DER (registered trademark)” 331, and “DER (registered trademark)” 332 (all manufactured by The Dow Chemical Co.), can be used.

As bisphenol F-type epoxy resins, commercial products, such as “jER (registered trademark)” 806, “jER (registered trademark)” 807, “jER (registered trademark)” 4004P (all manufactured by Mitsubishi Chemical Co.), “EPICLON (registered trademark)” 830 (manufactured by DIC Co.), “Epotohto (registered trademark)” YD-170, “Epotohto (registered trademark)” YDF-8170C, and “Epotohto (registered trademark)” YDF-870GS (all manufactured by Nippon Steel Chemical & Material Co., Ltd.), can be used.

As bisphenol AD-type epoxy resins, commercial products, such as EPOX-MK R710, and EPOX-MK R1710 (all manufactured by Printec Co.), can be used.

The amine-type epoxy resins used in the present invention include, for example, tetraglycidyl diaminodiphenylmethane, tetraglycidyl diaminodiphenyl sulfone, triglycidyl aminophenol, triglycidyl aminocresol, diglycidyl aniline, diglycidyl toluidine, tetraglycidyl xylylenediamine, and halogenated, alkylated, and hydrogenated derivatives thereof. Specific examples of the epoxy resins are described below.

Commercial tetraglycidyl diaminodiphenylmethane products include, for example, “SUMI-EPOXY (registered trademark)” ELM434 (manufactured by Sumitomo Chemical Co., Ltd.), YH434L (manufactured by Nippon Steel Chemical & Material Co., Ltd.), “jER (registered trademark)” 604 (manufactured by Mitsubishi Chemical Co.), “ARALDITE (registered trademark)” MY720, and “ARALDITE (registered trademark)” MY721 (all manufactured by Huntsman Advanced Materials).

Commercial tetraglycidyl diaminodiphenyl sulfone products include, for example, TG3DAS (manufactured by Mitsui Fine Chemicals, Inc.).

Commercial triglycidyl aminophenol or triglycidyl aminocresol products include, for example, “SUMI-EPOXY (registered trademark)” ELM100, “SUMI-EPOXY (registered trademark)” ELM120 (all manufactured by Sumitomo Chemical Co., Ltd.), “ARALDITE (registered trademark)” MY0500, “ARALDITE (registered trademark)” MY0510, “ARALDITE (registered trademark)” MY0600 (all manufactured by Huntsman Advanced Materials), and “jER (registered trademark)” 630 (manufactured by Mitsubishi Chemical Co.).

Preferably, an amine-type epoxy resin is used in combination with a bisphenol type epoxy resin for improving the balance between the high elastic modulus, the high heat resistance, and the high toughness.

In the present invention, the component [a] is preferably an epoxy resin containing less hydroxyl groups. Epoxy resins, including subcomponents thereof, often contain a small amount of hydroxyl groups, and the urethane-forming reaction occurring between the hydroxyl groups and an isocyanate curing agent may result in a decreased pot life or can provide a molded article with low wet heat resistance and/or poor toughness. The amount of hydroxyl groups contained in the component [a] is desired to be preferably not more than 0.50 mmol/g, more preferably not more than 0.30 mmol/g, still more preferably not more than 0.24 mmol/g, still more preferably not more than 0.16 mmol/g, still more preferably not more than 0.10 mmol/g, and still more preferably not more than 0.07 mmol/g. In cases where the amount of the hydroxyl groups is more than 0.50 mmol/g, the resulting epoxy resin composition may have high viscosity and a short pot life and can reduce the wet heat resistance and toughness of a molded article.

The amount of hydroxyl groups contained in the component [a] can be measured using, for example, the acetyl chloride-pyridine method in accordance with JIS K 0070 (1992). Specifically, in the acetyl chloride-pyridine method, the amount of hydroxyl groups is measured by dissolving a sample in pyridine, adding an acetyl chloride-toluene solution to the solution, heating the resulting mixture, adding water to the mixture for cooling, again boiling the resulting mixture to hydrolyze an excess amount of acetyl chloride, and then titrating the generated acetic acid with a potassium hydroxide-ethanol solution.

In the present invention, the component [b] is an isocyanate curing agent. The isocyanate curing agent is not limited to a specific isocyanate curing agent as long as the isocyanate curing agent is a compound containing an isocyanate group in the molecule, but a compound containing at least two isocyanate groups in the molecule is preferred. During thermal curing, the isocyanate group(s) is reacted with the oxirane group(s) of the component [a] to form a rigid structure(s) of oxazolidone ring, which causes a molded article to exhibit high wet heat resistance and excellent toughness.

As the isocyanate curing agent, an aromatic isocyanate, an aliphatic isocyanate, an alicyclic isocyanate, and the like can be used. Among others, an aromatic isocyanate containing an aromatic group(s) in the backbone of the molecule has high curing reactivity and exhibits excellent heat resistance and is therefore suitable for use.

Examples of the isocyanate curing agent that is suitable for use in the present invention include aliphatic isocyanates, such as methylene diisocyanate, ethylene diisocyanate, propylene diisocyanate, trimethylene diisocyanate, dodecamethylene diisocyanate, hexamethylene diisocyanate, tetramethylene diisocyanate, pentamethylene diisocyanate, propylene-1,2-diisocyanate, 2,3-dimethyltetramethylene diisocyanate, butylene-1,2-diisocyanate, butylene-1,3-diisocyanate, 1,4-diisocyanate hexane, cyclopentene-1,3-diisocyanate, isophorone diisocyanate, 1,2,3,4-tetraisocyanate butane, butane-1,2,3-triisocyanate, and α,α,α′,α′-tetramethylxylylene diisocyanate; aromatic isocyanates, such as p-phenylene diisocyanate, 1-methylphenylene-2,4-diisocyanate, naphthalene-1,4-diisocyanate, tolylene diisocyanate, diphenyl-4,4-diisocyanate, benzene-1,2,4-triisocyanate, xylylene diisocyanate, diphenylmethane diisocyanate (MDI), diphenylpropane diisocyanate, tetramethylene xylene diisocyanate, and polymethylene polyphenyl isocyanate; alicyclic isocyanates, such as cyclohexane diisocyanate, methylcyclohexane diisocyanate, trimethylhexamethylene diisocyanate, isophorone diisocyanate, lysine diisocyanate, methylene-bis(4-cyclohexylisocyanate), and isopropylidene-dicyclohexyl diisocyanate. These polyisocyanate compounds and the like may be used singly or in combination of two or more.

Commercial aliphatic isocyanate products include, for example, HDI (manufactured by Tosoh Co.), “DURANATE (registered trademark)” D101, and “DURANATE (registered trademark)” D201 (all manufactured by Asahi Kasei Co.).

Commercial aromatic isocyanate products include, for example, “Lupranate (registered trademark)” MS, “Lupranate (registered trademark)” MI, “Lupranate (registered trademark)” M20S, “Lupranate (registered trademark)” M11S, “Lupranate (registered trademark)” M5S, “Lupranate (registered trademark)” T-80, “Lupranate (registered trademark)” MM-103, “Lupranate (registered trademark)” MM-102, “Lupranate (registered trademark)” MM-301 (all manufactured by BASF INOAC Polyurethanes Ltd.), “Millionate (registered trademark)” MT, “Millionate (registered trademark)” MT-F, “Millionate (registered trademark)” MT-NBP, “Millionate (registered trademark)” NM, “Millionate (registered trademark)” MR-100, “Millionate (registered trademark)” MR-200, “Millionate (registered trademark)” MR-400, “Coronate (registered trademark)” T-80, “Coronate (registered trademark)” T-65, “Coronate (registered trademark)” T-100 (all manufactured by Tosoh Co.), “COSMONATE (registered trademark)” PH, “COSMONATE (registered trademark)” M-50, and “COSMONATE (registered trademark)” T-80 (all manufactured by Mitsui Chemicals, Inc.).

Commercial alicyclic isocyanate products include, for example, “TAKENATE (registered trademark)” 600 (manufactured by Mitsui Chemicals, Inc.) and “FORTIMO (registered trademark)” 1,4-H6XDI (manufactured by Mitsui Chemicals, Inc.).

A product of a preliminary reaction between the epoxy resin and the isocyanate resin curing agent or between parts thereof may be blended in the composition. This method may be effective in viscosity control or storage stability enhancement.

In the thermosetting epoxy resin composition of the invention, the stoichiometric ratio of the component [b] to the component [a] is in the range from 0.5 to 2.0. The stoichiometric ratio is the ratio of mole numbers of isocyanate groups contained in the component [b] to oxirane groups contained in the component [a], that is [b]/[a], and is also expressed as H/E. The H/E is desired to be preferably in the range from 0.75 to 1.5. In cases where the H/E is less than 0.5, the thermosetting epoxy resin composition is insufficiently cured, and the resulting cured product has low wet heat resistance and poor toughness, as well as the thermosetting epoxy resin composition fails to achieve both improved pot life and fast curability at low temperatures. On the other hand, in cases where H/E is more than 2.0, the thermosetting epoxy resin composition is insufficiently cured, and the resulting cured product has low wet heat resistance and poor toughness, as well as the fast curability of the thermosetting epoxy resin composition at low temperatures is insufficient.

In the present invention, the component [c] is a hydroxyl group capping agent. The hydroxyl group capping agent is a compound that can react with hydroxyl group to cap the hydroxyl group, that is, a compound that contains a protective functional group in the molecule. The hydroxyl group capping agent is a compound distinct from the component [b] in terms of chemical structure. The addition of the hydroxyl group capping agent results in capping of hydroxyl groups present in the thermosetting epoxy resin composition, particularly a small amount of hydroxyl groups that the epoxy resin of the component [a] often contains. The capping of hydroxyl groups disturbs the urethane-forming reaction between the isocyanate curing agent of the component [b], which is added separately, and the hydroxyl groups, and allows for preferential consumption of the hydroxyl groups in the curing reaction with the epoxy. Consequently, the pot life of the epoxy resin composition is increased without compromising the fast curability at low temperatures. Additionally, a molded article which absorbs only a small amount of water even in wet heat environments and is resistant to hydrolysis and has high wet heat resistance can be produced because a urethane structure is unlikely to be formed in the molded article. Furthermore, the preferential formation of a rigid structure of oxazolidone ring, together with the suppression of the side reaction, causes the molded article to have high toughness as well.

In the present invention, the peak temperature Tc of the exothermic reaction between the component [c] and a hydroxyl group is preferably 15° C. or more lower, more preferably 30° C. or more lower, still more preferably 45° C. or more lower, than the peak temperature Tb of the exothermic reaction between the component [b] and a hydroxyl group. The upper limit of the value of Tb−Tc is not specifically limited because a larger value of Tb−Tc is more desirable, but the value of Tb−Tc is normally around 100° C.

Tc is the peak temperature of the exothermic curve obtained by differential scanning calorimetry performed at a temperature ramp rate of 10° C./min on a mixture of 1-phenoxy-2-propanol and the component [c] in a mass ratio of 10:1. Tb is the peak temperature of the exothermic curve obtained by differential scanning calorimetry performed at a temperature ramp rate of 10° C./min on a mixture of 1-phenoxy-2-propanol and the component [b] in a mass ratio of 10:1. This causes hydroxyl groups present in the thermosetting epoxy resin composition to preferentially react with the hydroxyl group capping agent over the isocyanate curing agent and to be capped by the hydroxyl group capping agent. As a result, the isocyanate curing agent is consumed for the epoxy curing reaction but not for the urethane-forming reaction with hydroxyl groups, which greatly improves the pot life of the epoxy resin composition without reducing the curing reactivity. Moreover, a molded article with higher wet heat resistance and/or higher toughness is produced due to the rigid structure of oxazolidone ring preferentially formed over the other in the backbone of the molecule after the curing reaction. In cases where the peak temperature Tc of the exothermic reaction is higher than the temperature 15° C. lower than Tb, hydroxyl groups present in the thermosetting epoxy resin composition may react with the isocyanate curing agent preferentially over the hydroxyl group capping agent, which results in the urethane-forming reaction between the isocyanate curing agent and the hydroxyl groups and may compromise both the pot life and fast curability at low temperatures. Additionally, a urethane structure(s) with low wet resistance can be formed in a molded article, and the molded article may therefore be insufficient in terms of wet heat resistance and toughness.

In the present invention, the peak temperature Tc of the exothermic reaction between the component [c] and a hydroxyl group means the temperature at which the capping reaction of the hydroxyl group is allowed to proceed most vigorously in cases where the component [c] and a specific hydroxy-containing compound are mixed with each other and heated at a constant rate. Specifically, 1-phenoxy-2-propanol is prepared as a hydroxy-containing compound that mimics an epoxy resin containing hydroxyl groups. The hydroxy-containing compound and the component [c] are mixed in a mass ratio of 10:1, and differential scanning calorimetry (DSC) is performed on the mixture at a temperature ramp rate of 10° C./min. The peak temperature of the obtained exothermic curve is the exothermic peak temperature Tc of the hydroxyl group-capping reaction.

In the present invention, the peak temperature Tb of the exothermic reaction between the component [b] and a hydroxyl group means the temperature at which the urethane-forming reaction between the hydroxyl group and the isocyanate group of the component [b] is allowed to proceed most vigorously in cases where the component [b] and a specific hydroxy-containing compound are mixed with each other and heated at a constant rate. Specifically, 1-phenoxy-2-propanol is prepared as a hydroxy-containing compound that mimics an epoxy resin containing hydroxyl groups. The hydroxy-containing compound and the component [b] are mixed in a mass ratio of 10:1, and differential scanning calorimetry (DSC) is performed on the mixture at a temperature ramp rate of 10° C./min. The peak temperature of the obtained exothermic curve is the exothermic peak temperature Tb of the urethane-forming reaction.

In the present invention, the content of the component [c] in total is preferably not less than 0.5 part by mass and not more than 20 parts by mass, more preferably not less than 1 part by mass and not more than 15 parts by mass, still more preferably not less than 1 part by mass and not more than 10 parts by mass, relative to 100 parts by mass of the component [a] in total. In cases where the content of the component [c] is less than 0.5 part by mass, the pot life may not be enough long, and the wet heat resistance and toughness of a molded article may be insufficient. On the other hand, in cases where the content of the component [c] is more than 20 parts by mass, the fast curability at low temperatures may be insufficient, and the wet heat resistance of a molded article may be insufficient.

Preferably, in the present invention, the component [c] is at least one compound selected from the group consisting of the following compounds [I] to [VI], from the viewpoint of the reactivity with hydroxyl groups:
[I] a compound that contains at least one isocyanate group in the molecule;
[II] a compound that contains at least one carbodiimide group in the molecule;
[III] a compound that contains at least one acid anhydride structure in the molecule;
[IV] a compound that contains at least one orthoester structure in the molecule;
[V] a compound that contains at least one alkoxysilane structure in the molecule;
[VI] a compound that contains at least one oxazolidine structure in the molecule.

The component [c] is more preferably at least one compound selected from the group consisting of the following compounds [I] to [III] and is still more preferably the following compound [I] because such a compound easily reduces the increase of viscosity during capping of hydroxyl groups:
[I] a compound that contains at least one isocyanate group in the molecule;
[II] a compound that contains at least one carbodiimide group in the molecule;
[III] a compound that contains at least one acid anhydride structure in the molecule.

[I]: Examples of the compound that contains at least one isocyanate group in the molecule include aliphatic isocyanates, such as methyl isocyanate, ethyl isocyanate, n-propyl isocyanate, isopropyl isocyanate, n-butyl isocyanate, isobutyl isocyanate, octadecyl isocyanate, cyclohexyl isocyanate, chlorosulfonyl isocyanate, methylene diisocyanate, ethylene diisocyanate, trimethylene diisocyanate, dodecamethylene diisocyanate, hexamethylene diisocyanate, tetramethylene diisocyanate, pentamethylene diisocyanate, propylene diisocyanate, 2,3-dimethyltetramethylene diisocyanate, butylene-1,2-diisocyanate, butylene-1,3-diisocyanate, 1,4-diisocyanate hexane, cyclopentene-1,3-diisocyanate, 1,2,3,4-tetraisocyanate butane, and butane-1,2,3-triisocyanate; aromatic isocyanates, such as phenyl isocyanate, tolyl isocyanate, xylyl isocyanate, trimethylphenyl isocyanate, acetylphenyl isocyanate, ethoxyphenyl isocyanate, cyanophenyl isocyanate, dimethoxyphenyl isocyanate, naphthyl isocyanate, biphenylyl isocyanate, phenoxyphenyl isocyanate, fluorophenyl isocyanate, chlorophenyl isocyanate, bromophenyl isocyanate, benzenesulfonyl isocyanate, o-toluenesulfonyl isocyanate, p-toluenesulfonyl isocyanate, p-phenylene diisocyanate, 1-methylphenylene-2,4-diisocyanate, naphthalene-1,4-diisocyanate, tolylene diisocyanate, diphenyl-4,4-diisocyanate, benzene-1,2,4-triisocyanate, xylylene diisocyanate, α,α,α′,α′-tetramethylxylylene diisocyanate, diphenylmethane diisocyanate (MDI), diphenylpropane diisocyanate, tetramethylene xylene diisocyanate, and polymethylene polyphenyl isocyanate; and alicyclic isocyanates, such as methylene diisocyanate, lysine diisocyanate, cyclohexane diisocyanate, methylcyclohexane diisocyanate, trimethylhexamethylene diisocyanate, isophorone diisocyanate, methylene-bis(4-cyclohexylisocyanate), and isopropylidene-dicyclohexyl diisocyanate.

Among those, a compound that contains one isocyanate group in the molecule is preferred as the component [c] because the compound can reduce the increase of viscosity during capping of hydroxyl groups. Examples of the compound that contains one isocyanate group in the molecule include methyl isocyanate, ethyl isocyanate, n-propyl isocyanate, isopropyl isocyanate, n-butyl isocyanate, isobutyl isocyanate, octadecyl isocyanate, cyclohexyl isocyanate, chlorosulfonyl isocyanate, phenyl isocyanate, chlorophenyl isocyanate, tolyl isocyanate, xylyl isocyanate, trimethylphenyl isocyanate, acetylphenyl isocyanate, ethoxyphenyl isocyanate, cyanophenyl isocyanate, dimethoxyphenyl isocyanate, naphthyl isocyanate, biphenylyl isocyanate, phenoxyphenyl isocyanate, fluorophenyl isocyanate, bromophenyl isocyanate, benzenesulfonyl isocyanate, o-toluenesulfonyl isocyanate, and p-toluenesulfonyl isocyanate. Among those, sulfonyl isocyanate compounds, such as chlorosulfonyl isocyanate, benzenesulfonyl isocyanate, o-toluenesulfonyl isocyanate, and p-toluenesulfonyl isocyanate, are more suitable for use from the viewpoint of heat resistance.

[II]: Examples of the compound that contains at least one carbodiimide group in the molecule include dicarbodiimides, such as N,N′-diisopropylcarbodiimide, N,N′-dicyclohexylcarbodiimide, and N,N′-di-2,6-diisopropylphenylcarbodiimide; and polycarbodiimides, such as poly(1,6-hexamethylenecarbodiimide), poly[4,4′-methylene bis(cyclohexylcarbodiimide)], poly(1,3-cyclohexylene carbodiimide), poly(1,4-cyclohexylene carbodiimide), poly(4,4′-dicyclohexylmethanecarbodiimide), poly(4,4′-diphenylmethanecarbodiimide), poly(3,3′-dimethyl-4,4′-diphenylmethanecarbodiimide), poly(naphthalenecarbodiimide), poly(p-phenylenecarbodiimide), poly(m-phenylenecarbodiimide), poly(tolylcarbodiimide), poly(diisopropylcarbodiimide), poly(methyl-diisopropylphenylenecarbodiimide), poly(1,3,5-triisopropylbenzene) polycarbodiimide, poly(1,3,5-triisopropylbenzene) polycarbodiimide, poly(1,5-diisopropylbenzene) polycarbodiimide, poly(triethylphenylenecarbodiimide), and poly(triisopropylphenylenecarbodiimide).

[III]: Examples of the compound that contains at least one acid anhydride structure in the molecule include acetic anhydride, chloroacetic anhydride, dichloroacetic anhydride, trichloroacetic anhydride, trifluoroacetic anhydride, propionic anhydride, butyric anhydride, succinic anhydride, maleic anhydride, benzoic anhydride, phthalic anhydride, methyltetrahydrophthalic anhydride, hexahydrophthalic anhydride, methyl hexahydrophthalic anhydride, tetrahydrophthalic anhydride, methyl-tetrahydro-endomethylenephthalic anhydride, tetrahydro-endomethylenephthalic anhydride, methyl-bicycloheptanedicarboxylic acid anhydride, and bicycloheptanedicarboxylic acid anhydride.

[IV]: Examples of the compound that contains at least one orthoester structure in the molecule include trimethyl orthoformate, triethyl orthoformate, trimethyl orthoacetate, and triethyl orthoacetate.

[V]: Examples of the compound that contains at least one alkoxysilane structure in the molecule include tetramethoxysilane, tetraethoxysilane, tetrapropoxysilane, tetrabutoxysilane, tetraphenoxysilane, and dimethoxydiethoxysilane.

[VI]: Examples of the compound that contains at least one oxazolidine structure in the molecule include 3-ethyl-2-methyl-2-(3-methylbutyl)-1,3-oxazolidine.

The hydroxyl group capping agent [c] is not limited to the above compounds. Additionally, those hydroxyl group capping agents [c] may be used singly or in combination of two or more.

In the present invention, the component [d] is an epoxy curing catalyst that promotes the curing reaction of the oxirane group of the component [a] with the isocyanate group of the component [b]. The addition of the catalyst allows the oxazolidone cyclization reaction to proceed predominantly as well as improves the fast curability of the epoxy resin composition at low temperatures, which results in providing a molded article with high wet heat resistance and excellent toughness.

In the present invention, the component [d] is not limited to a specific compound but is preferably a base and/or an acid-base complex and is more preferably a base or an acid-base complex. The component [d] is still more preferably a Broensted base or an acid-base complex composed of a Broensted acid and a Broensted base and is particularly preferably an acid-base complex composed of a Broensted acid and a Broensted base. These catalysts may be used singly or in combination of two or more.

In the present invention, the Broensted base is a base that can accept a proton in a neutralization reaction with an acid. Examples of the Broensted base include 1,8-diazabicyclo[5.4.0]undec-7-ene, 1,5-diazabicyclo[4.3.0]-5-nonene, 7-methyl-1,5,7-triazabicyclo[4.4.0]dec-5-ene, and 1,5,7-triazabicyclo[4.4.0]dec-5-ene.

In the present invention, the Broensted acid is an acid that can donate a proton in a neutralization reaction with a base. As the Broensted acid, for example, a carboxylic acid, a sulfonic acid, or a hydrogen halides is suitable for use.

Examples of the carboxylic acid include formic acid, acetic acid, nitric acid, benzoic acid, phthalic acid, maleic acid, fumaric acid, malonic acid, tartaric acid, citric acid, lactic acid, succinic acid, monochloroacetic acid, dichloroacetic acid, trichloroacetic acid, trifluoroacetic acid, nitroacetic acid, and triphenylacetic acid.

Examples of the sulfonic acid include methanesulfonic acid, ethanesulfonic acid, benzenesulfonic acid, p-toluenesulfonic acid, and trifluoromethanesulfonic acid.

Examples of the hydrogen halide include hydrogen chloride, hydrogen bromide, and hydrogen iodide.

In the present invention, an onium halide complex is preferred as the acid-base complex of the component [d].

In the present invention, the onium halide complex is an onium complex with a halide ion, which is a counter anion. The onium halide complex is not limited to a specific onium halide complex but is preferably a quaternary ammonium halide complex and/or a quaternary phosphonium halide complex and is more preferably a quaternary ammonium halide complex or a quaternary phosphonium halide complex.

Examples of the quaternary ammonium halide complex include trimethyl(octadecyl)ammonium chloride, trimethyl(octadecyl)ammonium bromide, benzyltrimethylammonium chloride, benzyltrimethylammonium bromide, tetrabutylammonium chloride, tetrabutylammonium bromide, (2-methoxyethoxymethyl)triethylammonium chloride, (2-methoxyethoxymethyl)triethylammonium bromide, (2-acetoxyethyl)trimethylammonium chloride, (2-acetoxyethyl)trimethylammonium bromide, (2-hydroxyethyl)trimethylammonium chloride, (2-hydroxyethyl)trimethylammonium bromide, bis(polyoxyethylene)dimethylammonium chloride, bis(polyoxyethylene)dimethylammonium bromide, 1-hexadecylpyridinium chloride, and 1-hexadecylpyridinium bromide.

Examples of the quaternary phosphonium halide complex include trimethyl(octadecyl)phosphonium chloride, trimethyl(octadecyl)phosphonium bromide, benzyltrimethylphosphonium chloride, benzyltrimethylphosphonium bromide, tetrabutylphosphonium chloride, tetrabutylphosphonium bromide, (2-methoxyethoxymethyl)triethylphosphonium chloride, (2-methoxyethoxymethyl)triethylphosphonium bromide, (2-acetoxyethyl)trimethylphosphonium chloride, (2-acetoxyethyl)trimethylphosphonium bromide, (2-hydroxyethyl)trimethylphosphonium chloride, (2-hydroxyethyl)trimethylphosphonium bromide, bis(polyoxyethylene)dimethylphosphonium chloride, bis(polyoxyethylene)dimethylphosphonium bromide, tetraphenylphosphonium bromide, acetonyltriphenylphosphonium chloride, (4-carboxybutyl)triphenylphosphonium bromide, (4-carboxypropyl)triphenylphosphonium bromide, (2,4-dichlorobenzyl)triphenylphosphonium chloride, 2-dimethylaminoethyltriphenylphosphonium bromide, ethoxycarbonylmethyl(triphenyl)phosphonium bromide, (formylmethyl)triphenylphosphonium chloride, (N-methylanilino)triphenylphosphonium iodide, and phenacyltriphenylphosphonium bromide.

In the present invention, an inorganic salt is also preferred as the acid-base complex of the component [d]. The inorganic salt is a salt composed of a cation derived from an inorganic substance such as a metal element and an anion derived from a base and is not limited to a specific salt, but a halide of an alkali metal (alkali metal halide) is suitable for use.

Examples of the inorganic salt include calcium chloride, calcium bromide, calcium iodide, magnesium chloride, magnesium bromide, magnesium iodide, potassium chloride, potassium bromide, potassium iodide, sodium chloride, sodium bromide, sodium iodide, lithium chloride, lithium bromide, and lithium iodide.

The content of the component [d] in total is preferably not less than 1 part by mass and not more than 10 parts by mass, more preferably not less than 1 part by mass and not more than 5 parts by mass, still more preferably not less than 1 part by mass and not more than 3 parts by mass, relative to 100 parts by mass of the component [a] in total. In cases where the content of the component [d] is less than 1 part by mass, the fast curability of the epoxy resin composition at low temperatures may be insufficient. On the other hand, in cases where the content of the component [d] is less than 10 parts by mass, the pot life of the epoxy resin composition may not be enough long, and the wet heat resistance and toughness of a molded article may be insufficient.

Preferably, the component [d] is a catalyst that can be dissolved in the epoxy resin to achieve uniform catalysis during curing process. By the “catalyst that can be dissolved in the epoxy resin” is meant that the catalyst and the epoxy resin of the component [a] are homogeneously mixed with each other when 1 part of the catalyst is added to 100 parts of the component [a] in total and the resulting mixture is heated to room temperature or a temperature close to the melting point of the catalyst and then stirred for 30 minutes and then left to stand at room temperature for 1 hour. Whether or not the components are homogeneously mixed is determined using, for example, phase contrast microscope based on the presence or absence of the catalyst remaining insoluble.

The molded article of the invention is prepared by thermally curing the thermosetting epoxy resin composition of the invention. The thermal curing of the thermosetting epoxy resin composition provides the heat resistance and toughness as described above. Curing conditions such as curing temperature and curing time are appropriately determined depending on the catalyst type and the catalyst amount.

The first aspect of the fiber-reinforced composite material according to the present invention comprises the molded article of the invention and a reinforcing fiber. The presence of the reinforcing fiber achieves both light weight and excellent mechanical properties.

A molding material for fiber-reinforced composite material according to the present invention comprises the thermosetting epoxy resin composition of the invention and a reinforcing fiber. In the molding material for fiber-reinforced composite material according to the present invention, the reinforcing fiber may or may not yet have been impregnated with the epoxy resin composition. Additionally, the epoxy resin composition may not yet have been cured or may have been partially cured to the B-stage.

The second aspect of the fiber-reinforced composite material according to the present invention is prepared by thermally curing the molding material for fiber-reinforced composite material according to the present invention. The thermal curing allows the thermosetting epoxy resin composition to exhibit heat resistance and toughness, which provides both light weight and excellent mechanical properties to the fiber-reinforced composite material.

Examples of the reinforcing fiber used in the present invention include glass fiber, aramid fiber, carbon fiber, and boron fiber. Among those, carbon fiber is a preferred reinforcing fiber because a fiber-reinforced composite material that is not only light in weight but also has excellent mechanical properties such as strength and elastic modulus can be produced.

Preferably, the carbon fiber has a substantially perfect circular cross-section. By the “substantially perfect circular cross-section” is meant that the ratio of the minor axis r to the major axis R (r/R) is not less than 0.9, where the lengths of the minor and major axes of the cross-section are measured on a cross-section of a single filament by using an optical microscope. The major axis R refers to the diameter of the circumscribed circle of the cross-section of the single filament, and the minor axis r refers to the diameter of the inscribed circle of the cross-section of the single filament. When the cross-section is a perfect circle, a matrix of such carbon fibers is well impregnated with the thermosetting epoxy resin composition, and the risk of leaving unimpregnated areas can be reduced.

The carbon fiber preferably has an average fiber diameter in the range from 4.0 μm to 8.0 μm, more preferably from 5.0 μm to 7.0 μm, and still more preferably from 5.3 μm to 7.0 μm when the fiber diameter is measured using an optical microscope. The average fiber diameter in the above range allows both the impact resistance and the tensile strength to be achieved in a fiber-reinforced composite material in which the carbon fiber is used.

In the present invention, the reinforcing fiber is preferably a carbon fiber that satisfies the following conditions [A] and [B]:
[A] the carbon fiber has a substantially perfect circular cross-section;
[B] the carbon fiber has an average fiber diameter of 4.0 μm to 8.0 μm.

Preferably, the carbon fiber further satisfies the following condition [C]: [C] the carbon fiber has a surface oxygen concentration O/C ranging from 0.03 to 0.22.

In this respect, the surface oxygen concentration is determined in X-ray photoelectron spectroscopy by calculating the surface oxygen concentration O/C=([O₁ₛ]/[C₁ₛ])/(sensitivity correction value) from the O₁ₛ peak area [O₁ₛ] and the C₁ₛ peak area [C₁ₛ].

The surface oxygen concentration O/C is more preferably in the range from 0.05 to 0.22 and still more preferably in the range from 0.08 to 0.22. In cases where the O/C is not more than 0.22, a fiber-reinforced composite material in which such a carbon fiber is used is more likely to have sufficient tensile strength. In cases where the O/C is not less than 0.03, the adhesiveness of such a carbon fiber with the thermosetting epoxy resin composition is improved, and a fiber-reinforced composite material in which such a carbon fiber is used is more likely to have sufficient mechanical properties. Examples of a technique for limiting the surface oxygen concentration O/C to the above range include a method of changing the type or concentration of an electrolyte used for or the quantity of electricity applied for the electrolytic oxidation.

The carbon fiber can be used in combination with, for example, an inorganic fiber, such as glass fiber, metal fiber, or ceramic fiber, or a synthetic organic fiber, such as polyamide fiber, polyester fiber, polyolefin fiber, or novoloid fiber, or a metal wire made of, for example, gold, silver, copper, bronze, brass, phosphor bronze, aluminium, nickel, steel, or stainless steel, or a metal mesh, or a metal non-woven fabric, as long as the effects of the invention are not impaired.

The content of the carbon fiber is preferably not less than 30% by mass, more preferably not less than 50% by mass, still more preferably not less than 70% by mass, of the total fibers. In cases where the content of the carbon fiber is within the above range, a fiber-reinforced composite material with light weight and excellent mechanical properties can be preferably obtained.

In the present invention, a sizing agent comprising a thermoplastic resin is attached to the carbon fiber, and the amount of the attached sizing agent is preferably in the range from 0.1% to 1.5% by mass relative to the total amount of the carbon fiber and the sizing agent, which is taken as 100% by mass. In cases where the amount of the attached sizing agent is not less than 0.1% by mass, the bundling of fibers is improved, which makes it easier to reduce the risk of fluffing during matrix production or the risk of void formation in a molded article. In cases where the amount of the attached sizing agent is not more than 1.5% by mass, adverse effects on the color, heat resistance, and mechanical properties of carbon fibers can be reduced.

The thermoplastic resin contained in the sizing agent is not limited to a specific resin as long as the resin component is thermoplastic. Examples of the thermoplastic resin include polyacrylate, polymethacrylate, polycarbonate, polyether, polyester, and polyurethane. The number of repeating units in the backbone of the thermoplastic resin and the molecular weight of the thermoplastic resin are not specifically limited but can be selected depending on the requirements such as moldability, quality, and mechanical properties.

In the present invention, the content of the thermoplastic resin is preferably not less than 15% by mass relative to the total amount of the sizing agent, which is taken as 100% by mass. In cases where the content of the thermoplastic resin is within the above range, a fiber-reinforced composite material with high tensile strength can be preferably obtained.

In the present invention, the sizing agent preferably further comprises an aromatic epoxy resin. The aromatic epoxy resin is not limited to a specific resin as long as the resin is an epoxy resin having an aromatic backbone. Examples of the aromatic epoxy resin include bisphenol type epoxy resins and amine-type epoxy resins. The bisphenol bone or amine bone in the epoxy resin may be a polymer composed of multiple repeating units or a monomer composed of a single repeating unit and can be selected depending on the requirements such as moldability, quality, and mechanical properties.

In the present invention, the content of the aromatic epoxy resin in the sizing agent is preferably not less than 15% by mass and not more than 60% by mass relative to the total amount of the sizing agent, which is taken as 100% by mass. In cases where the content of the aromatic epoxy resin is within the above range, an appropriate level of interfacial adhesion is achieved between the carbon fiber and the matrix resin, which makes it easier to provide a fiber-reinforced composite material with both high in-plane shear strength and high tensile strength.

In the present invention, the reinforcing fiber is preferably a glass fiber. The glass fiber allows for cost and weight savings in fiber-reinforced composite materials for automobiles, aircrafts, and large members, such as a wind turbine blade.

In the present invention, the reinforcing fiber is preferably a glass fiber having a surface functional group capable of covalent bonding to an isocyanate group. It is known that silicon-bonded hydroxyl groups (Si—OH) called silanol groups are on the surface of glass fibers, and that the surface chemical properties of glass fibers can be improved by attaching a coupling agent with a different functional group, as needed, to the silanol group. By the phrase “having a surface functional group capable of covalent bonding to an isocyanate group” is meant at least one functional group capable of reacting with an isocyanate group to form a covalent bond resides on the surface of glass fibers. In cases where glass fibers have a surface functional group capable of forming a covalent bond with an isocyanate group, the glass fibers can form a chemical linkage with an isocyanate curing agent contained as the component [b] in the thermosetting epoxy resin composition, by which the adhesiveness of the glass fibers with the thermosetting epoxy resin composition is increased in the resulting fiber-reinforced composite material and the strength is more likely increased. However, in cases where the adhesiveness of the glass fibers with the epoxy resin composition is too high, the tensile strength may be reduced, as described below. Therefore, it is preferred that the surface of the glass fibers be appropriately treated with a coupling agent or the like.

Preferably, the surface functional group of the glass fiber is at least one functional group selected from the group consisting of hydroxyl group, oxirane group, amino group, thiol group, and carboxy group. The presence of the surface functional group as described above on the surface of the glass fiber is more likely to provide excellent adhesiveness at the interface between the glass fiber and the thermosetting epoxy resin composition. Among those, amino group is preferred as the surface functional group of the glass fiber because amino group is compatible with the epoxy resin composition and is moderately likely to form a covalent bond with the isocyanate curing agent [b].

Preferably, a functional group with an active hydrogen resides on the surface of the glass fiber. The active hydrogen refers to a highly reactive hydrogen atom that is bound to a nitrogen, oxygen, or sulfur atom in an organic compound. For example, one amino group contains two active hydrogens. Examples of the functional group with an active hydrogen include hydroxyl group, oxirane group, amino group, thiol group, and carboxy group.

Preferably, the surface functional group of the glass fiber is formed by treatment with at least one selected from the group consisting of a silane coupling agent, a titanate coupling agent, an aluminate coupling agent, and a zirconium coupling agent. The coupling agents may be used singly or in combination of two or more. In cases where the amount of silanol groups on the surface of a glass fiber is too high, the glass fiber is firmly attached by a chemical bond to the isocyanate curing agent [b] contained in the epoxy resin composition and the adhesiveness is increased, but the epoxy resin may be fractured without gaining the benefit of the strength of the glass fiber when a tensile stress is applied to the resulting fiber-reinforced composite material, which results in reduction of tensile strength. Therefore, it is preferred that the surface of the glass fibers be appropriately treated with a coupling agent or the like.

Examples of the silane coupling agent can include amino-containing silanes, such as γ-aminopropyltrimethoxysilane, γ-aminopropyltriethoxysilane, γ-aminopropyltriisopropoxysilane, γ-aminopropylmethyldimethoxysilane, γ-aminopropylmethyldiethoxysilane, γ-(2-aminoethyl)aminopropyltrimethoxysilane, γ-(2-aminoethyl)aminopropylmethyldimethoxysilane, γ-(2-aminoethyl)aminopropyltriethoxysilane, γ-(2-aminoethyl)aminopropylmethyldiethoxysilane, γ-(2-aminoethyl)aminopropyltriisopropoxysilane, γ-ureidopropyltrimethoxysilane, N-phenyl-γ-aminopropyltrimethoxysilane, N-benzyl-γ-aminopropyltrimethoxysilane, and N-vinylbenzyl-γ-aminopropyltriethoxysilane; thiol-containing silanes, such as γ-mercaptopropyltrimethoxysilane, γ-mercaptopropyltriethoxysilane, γ-mercaptopropylmethyldimethoxysilane, and γ-mercaptopropylmethyldiethoxysilane; oxirane-containing silanes, such as γ-glycidoxypropyltrimethoxysilane, γ-glycidoxypropyltriethoxysilane, γ-glycidoxypropylmethyldimethoxysilane, β-(3,4-epoxycyclohexyl)ethyltrimethoxysilane, and β-(3,4-epoxycyclohexyl)ethyltriethoxysilane; and carboxy-containing silanes, such as β-carboxyethyltriethoxysilane, β-carboxyethylphenylbis(2-methoxyethoxy)silane, and N-β-(carboxymethyl)aminoethyl-γ-aminopropyltrimethoxysilane.

Examples of the titanate coupling agent include isopropyl tri(N-aminoethyl-aminoethyl)titanate, tetraoctyl bis(ditridecylphosphite)titanate, tetra(2,2-diallyloxymethyl-1-butyl) bis(ditridecyl phosphite)titanate, bis(dioctylpyrophosphate)oxyacetate titanate, bis(dioctylpyrophosphate)ethylene titanate, isopropyltrioctanoyl titanate, isopropyldimethacrylisostearoyl titanate, isopropyltridecylbenzenesulfonyl titanate, isopropylisostearoyldiacryl titanate, isopropyltri(dioctylphosphate)titanate, isopropyltricumylphenyl titanate, and tetraisopropylbis(dioctylphosphite)titanate.

Among those, an amino-containing silane is preferred as the silane coupling agent because an amino-containing silane is compatible with the epoxy resin composition and can moderately increase the adhesive strength and impact resistance.

In cases where the glass fiber comprises a coupling agent, the content of the coupling agent is preferably from 0.01 part to 5 parts by mass, more preferably from 0.05 part to 4 parts by mass, still more preferably from 0.1 part to 3 parts by mass, relative to 100 parts by mass of the glass fiber. In cases where the content of the coupling agent is within the above range, the wettability of the thermosetting epoxy resin composition to the glass fiber is improved, and the adhesiveness and impregnating property of the thermosetting epoxy resin composition are moderately increased, and a fiber-reinforced composite material with higher mechanical properties can be preferably obtained.

Examples of a method of forming a coupling agent layer include a method in which a solution containing a coupling agent is applied on the surface of a matrix of glass fibers and then treated by heat. A solvent is used for preparing the solution of the coupling agent, and the solvent is not limited to a specific solvent as long as the solvent will not react with the coupling agent. Examples of the solvent include aliphatic hydrocarbon solvents, such as hexane; aromatic solvents, such as benzene, toluene, and xylene; ether solvents, such as tetrahydrofuran; alcohol solvents, such as methanol and propanol; ketone solvents, such as acetone; and water. These solvents are used singly or in combination of two or more.

As the glass fiber, any type of glass fiber can be used depending on applications. Examples of the glass fiber include E-glass fibers, A-glass fibers, C-glass fibers, D-glass fibers, R-glass fibers, S-glass fibers, ECR-glass fibers, NE-glass fibers, quartz fibers, and fibers prepared from glass compositions that can be used for fiber production, which are commonly known as fluorine-free and/or boron-free E-grass derivatives.

The glass fibers can be used in combination with, for example, an inorganic fiber, such as carbon fiber, metal fiber, or ceramic fiber, a synthetic organic fiber, such as polyamide fiber, polyester fiber, polyolefin fiber, or novoloid fiber, a metal wire made of, for example, gold, silver, copper, bronze, brass, phosphor bronze, aluminium, nickel, steel, or stainless steel, or a metal mesh, or a metal non-woven fabric, as long as the effects of the invention are not impaired.

The content of the glass fiber is preferably not less than 30% by mass, more preferably not less than 50% by mass, still more preferably not less than 70% by mass, of the total fibers. In cases where the content of the glass fiber is within the above range, a fiber-reinforced composite material with light weight and excellent mechanical properties and weather resistance can be preferably obtained.

The reinforcing fiber may be either a short fiber or a continuous fiber or can be a combination of both the fibers. A continuous fiber is preferred to obtain a fiber-reinforced composite material with excellent mechanical properties and a high fiber volume content (Vf).

In the fiber-reinforced composite material according to the present invention, the reinforcing fiber can be used in the form of strands, but a matrix of reinforcing fibers formed into a mat, a woven fabric, a knit, a braid, a unidirectional sheet, or the like is suitable for use. Among those, a woven fabric is suitable for use because a woven fabric is likely to give a fiber-reinforced composite material with a high Vf and is easy to handle.

The production of the fiber-reinforced composite material is not limited to a specific method, but a high-throughput production method such as the RTM (resin transfer molding) method, the resin film infusion method, the pultrusion method, or the press forming method, is suitable for use. Among those, the RTM method and the pultrusion method are more preferably used, and the RTM method is particularly preferably used.

The first aspect of the method of the invention for producing a fiber-reinforced composite material comprises impregnating reinforcing fibers with the thermosetting epoxy resin of the invention and then curing the thermosetting epoxy resin by heat.

In the first aspect of the method of the invention for producing a fiber-reinforced composite material, it is preferred that reinforcing fibers be continuously pulled through an impregnation bath of the thermosetting epoxy resin composition and then through a squeeze die and a heating mold by a pulling machine, where the impregnated fibers are molded and cured. Additionally, the molded article may be post-cured to increase the heat resistance or complete the reaction of epoxy groups. The molded article may be cured in a curing oven placed on the line after the molded article is discharge from the mold and before the molded article is wound up or can be cured in an oven after the molded article is wound up.

The second aspect of the method of the invention for producing a fiber-reinforced composite material comprises placing a woven fabric composed primarily of reinforcing fibers into a mold, impregnating the woven fabric with the thermosetting epoxy resin composition of the invention injected into the mold, and then curing the thermosetting epoxy resin composition by heat. The phrase “composed primarily of” refers to a component that accounts for the largest proportion in mass among the components of the woven fabric.

In the second aspect of the method of the invention for producing a fiber-reinforced composite material, it is preferred that the thermosetting epoxy resin composition be injected through multiple injection ports into the mold for impregnating the woven fabric composed primarily of reinforcing fibers placed in the mold with the thermosetting epoxy resin composition. Specifically, a variety of molded articles with different shapes and sizes can preferably be provided by using a mold with multiple injection ports and selecting optimal injection conditions according to a desired fiber-reinforced composite material, such as injecting the thermosetting epoxy resin composition through the multiple injection ports simultaneously or sequentially with time intervals. The number and shape of the injection ports are not limited, but it is convenient that more injection ports enable the injection to be completed in a shorter time, and it is preferred that the injection ports be positioned to provide a short flow length of the resin depending on the shape of a molded article.

A pressure from 0.1 MPa to 1.0 MPa is normally used to inject the thermosetting epoxy resin composition, and an injection pressure from 0.1 MPa to 0.6 MPa is preferred from the viewpoint of injection time and economy of equipment utilization. Moreover, the VaRTM (vacuum-assisted resin transfer molding) method can also be used, in which the thermosetting epoxy resin composition is injected into a mold under vacuum. Even in cases of high-pressure injection, it is advantageous that a mold is vacuumed before injection of the thermosetting epoxy resin composition to reduce the generation of voids.

In the method of the invention for producing a fiber-reinforced composite material, it is preferable to use a two-component-type thermosetting epoxy resin composition from the viewpoint of storage stability. Among two-component-type thermosetting epoxy resin compositions, a thermosetting epoxy resin composition made by blending a main agent solution comprising the components [a] and [c] with a curing agent solution comprising the components [b] and [d] is preferred. In this case, such a type of thermosetting epoxy resin composition is preferred because hydroxyl groups contained in the component [a] can be preliminarily reacted with the component [c] and the temperature rise is suppressed when a main agent solution is mixed with a curing agent solution.

Moreover, in the method of the invention for producing a fiber-reinforced composite material, it is preferable that the thermosetting epoxy resin composition is made by blending a main agent solution comprising the components [a] and [d] with a curing agent solution comprising the components [b] and [c]. This case is preferred because both the main agent solution and the curing agent solution are preferably maintained stable from the viewpoint of viscosity even after a long-term storage.

The pot life, which is an effect of the present invention, refers to a period of time during which a resin composition can maintain a liquid form with a low viscosity, in the molding process, to be injected into a mold or impregnate a matrix. It is preferred that the resin composition keep a longer pot life even at higher temperatures. The pot life is not limited to a specific parameter, but available parameters include, for example, the time required by the resin composition to reach a predetermined upper limit of viscosity or to undergo gelation under predetermined isothermal conditions, and the temperature required by the resin composition to reach a predetermined upper limit of viscosity or to undergo gelation under predetermined temperature-rising conditions.

The fast curability at low temperatures, which is an effect of the present invention, refers to that a resin composition is thermally cured at a low temperature in a short time in the molding process to provide mechanical properties needed by a desired molded article. It is preferred that the resin composition be cured at a lower temperature in a shorter period of time. The fast curability at low temperatures is not limited to a specific parameter, but available parameters include, for example, the time required by the resin composition to reach a predetermined stiffness or degree of cure under predetermined isothermal conditions, and the temperature required by the resin composition to reach a predetermined stiffness or degree of cure under predetermined temperature-rising conditions.

### EXAMPLES

The present invention will be described in more details by the following examples, but the present invention is not limited to the examples.

Examples 1 to 30 and Comparative Examples 1 to 6 are as follows (including Tables 1 to 4).

### (1) Raw Materials for Thermosetting Epoxy Resin Compositions

The following raw materials were used to obtain the epoxy resin compositions of the examples.

[a] Epoxy Resin
“jER (registered trademark)” 828 (bisphenol A-type epoxy resin, epoxy equivalent weight: 189, manufactured by Mitsubishi Chemical Co.)
“Epotohto (registered trademark)” YD-8125 (bisphenol A-type epoxy resin, epoxy equivalent weight: 173, manufactured by Nippon Steel Chemical & Material Co., Ltd.)
“jER (registered trademark)” 1002 (solid bisphenol A-type epoxy resin, epoxy equivalent weight: 650, manufactured by Mitsubishi Chemical Co.)
“ARALDITE (registered trademark)” MY721 (tetraglycidyl diaminodiphenylmethane, epoxy equivalent weight: 113, manufactured by Huntsman Advanced Materials)
   [b] Isocyanate Curing Agent
“Lupranate (registered trademark)” M20S (polymeric MDI, isocyanate equivalent weight: 134, manufactured by BASF INOAC Polyurethanes Ltd.)
“Lupranate (registered trademark)” MI (Monomeric MDI, isocyanate equivalent weight: 126, manufactured by BASF INOAC Polyurethanes Ltd.)
“Coronate (registered trademark)” L (TDI adduct, isocyanate equivalent weight: 318, manufactured by Tosoh Co.)
   [c] Hydroxyl Group-Capping Agent
Chlorophenyl isocyanate (4-chlorophenyl isocyanate, manufactured by Tokyo Chemical Industry Co., Ltd.)
Toluenesulfonyl isocyanate (p-toluenesulfonyl isocyanate, manufactured by Tokyo Chemical Industry Co., Ltd.)
Chloroacetic anhydride (manufactured by Tokyo Chemical Industry Co., Ltd.)
   [d] Epoxy Curing Catalyst
“DBU (registered trademark)” (1,8-diazabicyclo[5.4.0]undec-7-ene, manufactured by San-Apro Ltd.)
TBD/dichloroacetic acid

A white solid obtained by mixing equimolar amounts of TBD (1,5,7-triazabicyclo[4.4.0]dec-5-ene, manufactured by Tokyo Chemical Industry Co., Ltd.) and dichloroacetic acid (manufactured by Tokyo Chemical Industry Co., Ltd.) to a homogeneous blend.
1-Butyl-3-methylimidazolium bromide (manufactured by Tokyo Chemical Industry Co., Ltd.)
Tetrabutylammonium nitrate (manufactured by Tokyo Chemical Industry Co., Ltd.)
Tetrabutylammonium bromide (manufactured by Tokyo Chemical Industry Co., Ltd.)
Tetrabutylammonium chloride (manufactured by Tokyo Chemical Industry Co., Ltd.)
“Hokko TBP-BB (registered trademark)” (tetrabutylphosphonium bromide, manufactured by Hokko Chemical Industry Co., Ltd.)
Dibutylamine (manufactured by Tokyo Chemical Industry Co., Ltd.)
Calcium iodide (manufactured by Sigma-Aldrich, LLC)
Lithium bromide (manufactured by Tokyo Chemical Industry Co., Ltd.)
Lithium chloride (manufactured by Tokyo Chemical Industry Co., Ltd.)
   (2) Measurement of the Amount of Hydroxyl Groups Contained in the Component [a]

The hydroxyl value (unit: mg KOH/g) of a component [a] was determined via titration based on the acetyl chloride-pyridine method in accordance with JIS K 0070 (1992), and the hydroxyl value was divided by the formula weight of potassium hydroxide (56.11) to calculate the amount of hydroxyl groups (unit: mmol/g) in the component [a]. Specifically, in the acetyl chloride-pyridine method, the amount of hydroxyl groups is measured by dissolving a sample in pyridine, adding an acetyl chloride-toluene solution to the solution, heating the resulting mixture, adding water to the mixture for cooling, again boiling the resulting mixture to hydrolyze an excess amount of acetyl chloride, and then titrating the generated acetic acid with a potassium hydroxide-ethanol solution.

(3) Measurement of the Peak Temperature Tb of the Exothermic Reaction Between the Component [b] and a Hydroxyl Group

A mixture comprising 10 parts by mass of a component [b] and 100 parts by mass of 1-phenoxy-2-propanol, a hydroxy-containing compound, (manufactured by Tokyo Chemical Industry Co., Ltd.) was prepared, and the resulting mixture was analyzed by differential scanning calorimetry using a differential scanning calorimeter (DSC2910: manufactured by TA instruments, Inc.) at a temperature ramp rate of 10° C./min in the temperature range of 0° C. to 250° C. The exothermic peak temperature of the urethane-forming reaction in the obtained exothermic curve was determined as Tb.

(4) Measurement of the Peak Temperature Tc of the Exothermic Reaction Between the Component [c] and a Hydroxyl Group

A mixture comprising 10 parts by mass of a component [c] and 100 parts by mass of 1-phenoxy-2-propanol, a hydroxy-containing compound, (manufactured by Tokyo Chemical Industry Co., Ltd.) was prepared, and the resulting mixture was analyzed by differential scanning calorimetry using a differential scanning calorimeter (DSC2910: manufactured by TA instruments, Inc.) at a temperature ramp rate of 10° C./min in the temperature range of 0° C. to 250° C. The exothermic peak temperature of the hydroxyl group-capping reaction in the obtained exothermic curve was determined as Tc.

### (5) Preparation of Thermosetting Epoxy Resin Compositions

According to each of the compositions (in mass ratio) shown in Tables 1 to 4, a component [a] and a component [d] were combined, and the dissolution of these components was confirmed with a phase contrast microscope before a component [c] and a component [b] were added to the solution to prepare a thermosetting epoxy resin composition.

### (6) Measurement of the Viscosity of Thermosetting Epoxy Resin Compositions

The complex viscosity η* of each thermosetting epoxy resin composition prepared in the above subsection (5) at 25° C. was measured using a dynamic viscoelasticity-measuring apparatus (ARES: manufactured by TA instruments, Inc.) and parallel plates with a diameter of 40 mm under measurement conditions of 1-Hz frequency and 1-mm gap.

### (7) Measurement of the Gelation Temperature of Thermosetting Epoxy Resin Compositions

The temporal change in dynamic viscoelasticity of each thermosetting epoxy resin composition prepared in the above subsection (5) during a temperature rise from 30° C. to 300° C. at a temperature ramp rate of 10° C./min was measured using a polymer cure test apparatus (ATD-1000: manufactured by Alpha Technologies) under conditions of 1-Hz frequency and 10% strain, and the temperature at which the complex viscosity η* reached 1000 Pa·s was determined as the gelation temperature of the thermosetting epoxy resin composition.

### (8) Measurement of the Curing Temperature of Thermosetting Epoxy Resin Compositions

The temporal change in dynamic viscoelasticity of each thermosetting epoxy resin composition prepared in the above subsection (5) during a temperature rise from 30° C. to 300° C. at a temperature ramp rate of 10° C./min was measured using a polymer cure test apparatus (ATD-1000: manufactured by Alpha Technologies) under conditions of 1-Hz frequency and 1% strain, and the temperature at which the complex viscosity η* reached the saturation was determined as the curing temperature of the thermosetting epoxy resin composition. The saturation refers to the condition where the slope of the curing curve is decreased to one thirtieth of the maximum slope of the curing curve after the maximum slope of the curing curve is observed during the temperature rising phase in a scatter plot with common logarithm of η* on the vertical axis and temperature on the horizontal axis. This curing temperature indicates the fast curability of the resin composition at low temperatures. Moreover, the achievement of both improved pot life and fast curability at low temperatures, which is one of the effect of the present invention, is indicated by that the difference of the curing temperature from the gelation temperature obtained in the above subsection (7) is small.

### (9) Production of Molded Articles

Each thermosetting epoxy resin composition prepared in the above subsection (5) was vacuumed for defoaming and then heated at a rate of 10° C./min from a normal temperature to the curing temperature determined in the above subsection (8) under a pressing pressure of 1 MPa by using a compression molding machine, followed by immediate demolding to produce a plate-like molded article with a thickness of 2 mm.

For all the production of molded articles of Examples 24 to 30, the temperature was raised at a rate of 10° C./min from a normal temperature to 200° C. to obtain plate-shaped molded articles. Because the curing temperatures determined for Examples 24 to 30 in the above subsection (8) were much lower than those determined for Examples 1 to 23 and Comparative Examples 1 to 6, this range of temperature rise was applied for the purpose of evening out the level of comparison or evaluation.

### (10) Measurement of the Glass Transition Temperature of Molded Articles

A test piece with a size of 10 mm in width×40 mm in length was cut from each molded article produced in the above subsection (9), and the test piece was placed in a solid screw clamp and then analyzed in the temperature range from 30° C. to 300° C. by using a dynamic viscoelasticity-measuring apparatus (ARES: manufactured by TA instruments, Inc.) at a temperature ramp rate of 5° C./min, a frequency of 1 Hz, and a strain of 0.1%. In a scatter plot with common logarithm of storage modulus on the vertical axis and temperature on the horizontal axis, the temperature at the intersection between the tangent to the curve in the glass range and the tangent to the curve in the glass transition range was determined as the glass transition temperature.

In addition, the test piece described above was immersed in hot water at 70° C. for 14 days and then analyzed using the dynamic viscoelasticity-measuring apparatus by the same procedure as described above to determine the glass transition temperature after wet-heat treatment.

### (11) Measurement of the Bending Deflection of Molded Articles

A test piece with a size of 10 mm in width×60 mm in length was cut from each molded article produced in the above subsection (9), and the three-point bending test was performed on the test piece with a span distance of 32 mm to determine the bending deflection according to JIS K7171-1994. Additionally, the bending deflection based on the assumption that the glass transition temperature after wet-heat treatment was 150° C., that is, the normalized bending deflection was calculated according to the following equation 1. The achievement of both wet heat resistance and toughness, which is one of the effects of the present invention, is indicated by that the value of the normalized bending deflection is large.

Ds=D+0.14×(Tgw−150) (Equation 1)

[D: bending deflection (mm), Ds: normalized bending deflection (mm), Tgw: glass transition temperature after wet-heat treatment (° C.)]

### Example 1

A thermosetting epoxy resin composition was prepared in the same manner as described above according to the number of parts (parts by mass) specified in the composition column in Table 1. The thermosetting epoxy resin composition had a difference of 51° C. between the curing temperature and the gelation temperature, which was satisfactory, and a normalized bending deflection of 8.4 mm, which was acceptable.

### Example 2

The component [d] was changed from that used in Example 1 to an acid-base complex catalyst. The thermosetting epoxy resin composition had a difference of 55° C. between the curing temperature and the gelation temperature, which was satisfactory, and a normalized bending deflection of 8.8 mm, which was acceptable.

### Example 3

The component [c] was changed from that used in Example 2 to a high-activity species. The thermosetting epoxy resin composition had a difference of 48° C. between the curing temperature and the gelation temperature, which was slightly improved and satisfactory, and a normalized bending deflection of 9.7 mm, which was satisfactory.

### Example 4

The component [c] was changed from that used in Example 2 to a low-activity species. The thermosetting epoxy resin composition had a difference of 61° C. between the curing temperature and the gelation temperature, which was acceptable, and a normalized bending deflection of 8.0 mm, which was acceptable.

### Example 5

A portion of the component [a] of Example 3, which was 30 parts by mass, was replaced by a species containing less hydroxyl groups. The thermosetting epoxy resin composition had a difference of 38° C. between the curing temperature and the gelation temperature, which was good, and a normalized bending deflection of 11.2 mm, which was good.

### Example 6

A portion of the component [a] of Example 3, which was 70 parts by mass, was replaced by the species containing less hydroxyl groups. The thermosetting epoxy resin composition had a difference of 29° C. between the curing temperature and the gelation temperature, which was excellent, and a normalized bending deflection of 12.9 mm, which was excellent.

### Example 7

All of the component [a] of Example 3 was replaced by the species containing less hydroxyl groups. The thermosetting epoxy resin composition had a difference of 19° C. between the curing temperature and the gelation temperature, which was particularly excellent, and a normalized bending deflection of 14.4 mm, which was particularly excellent.

### Examples 8 to 11

The blending amount of the component [c] was increased or decreased as compared to that in Example 7. In any of the examples, the difference between the curing temperature and the gelation temperature was increased but was still at least acceptable, and the normalized bending deflection was reduced but was still at least acceptable.

### Examples 12 to 15

The blending amount of the component [b] was increased or decreased as compared to that in Example 7. In any of the examples, with such thermosetting epoxy compositions, the difference between the curing temperature and the gelation temperature was increased but was still at least acceptable, and the normalized bending deflection was reduced but was still at least acceptable.

### Example 16

An amine-type epoxy was used in combination with the epoxy of Example 7 as the component [a], and the component [b] was changed to a bifunctional curing agent. The thermosetting epoxy resin composition had a difference of 18° C. between the curing temperature and the gelation temperature, which was particularly excellent, and a normalized bending deflection of 14.3 mm, which was particularly excellent.

### Examples 17 and 18

The component [d] was changed from that used in Example 7 to different acid-base complex catalysts. In any of the examples, the difference between the curing temperature and the gelation temperature was increased but was still at least acceptable, and the normalized bending deflection was reduced but was still at least acceptable.

### Examples 19 to 21

The component [d] was changed from the acid-base complex catalyst used in Example 7 to an onium halide complex. In any of the examples, the difference between the curing temperature and the gelation temperature was increased but was still at least acceptable, and the normalized bending deflection remained at a particularly high level.

### Examples 22 and 23

The blending amount of the component [b] was increased or decreased as compared to that in Example 19. In any of the examples, with such thermosetting epoxy resin compositions, the difference between the curing temperature and the gelation temperature was increased but was still at least acceptable, and the normalized bending deflection was reduced but still remained at a particularly high level.

### Examples 24 to 26

The component [d] was changed from the acid-base complex catalyst used in Example 7 to an inorganic salt. The thermosetting epoxy resin compositions had a difference of 12° C. to 29° C. between the curing temperature and the gelation temperature, which was particularly excellent. Additionally, the normalized bending deflection was reduced but was still acceptable.

### Examples 27 and 28

The blending amount of the component [b] was increased or decreased as compared to that in Example 25. The thermosetting epoxy resin compositions had a large difference between the curing temperature and the gelation temperature, which was particularly excellent, and was excellent in curability at low temperatures. The normalized bending deflection was 8.5 mm or 10.7 mm, which was acceptable.

### Examples 29 and 30

The blending amount of the component [b] was increased or decreased as compared to that in Example 26. The thermosetting epoxy resin compositions had a large difference between the curing temperature and the gelation temperature, which was excellent, and was excellent in curability at low temperatures. The normalized bending deflection was 7.7 mm or 9.0 mm, which was acceptable.

### Comparative Example 1

The component [c] was excluded from the composition of Example 3. The thermosetting epoxy resin composition had a difference of 79° C. between the curing temperature and the gelation temperature, which was unsatisfactory, and a normalized bending deflection of 4.3 mm, which was unsatisfactory.

### Comparative Example 2

The component [d] was excluded from the composition of Example 3. In the thermosetting epoxy resin composition, the curing reaction did not proceed sufficiently, which provided no molded article.

### Comparative Example 3

The blending amount of the component [b] was decreased as compared to that in Example 7 to reduce the H/E to 0.3. The thermosetting epoxy resin composition had a difference of 56° C. between the curing temperature and the gelation temperature, which was acceptable, and a normalized bending deflection of 2.5 mm, which was unsatisfactory.

### Comparative Example 4

The blending amount of the component [b] was increased as compared to that in Example 7 to increase the H/E to 2.5. The thermosetting epoxy resin composition had a difference of 44° C. between the curing temperature and the gelation temperature, which was satisfactory, and a normalized bending deflection of 4.3 mm, which was unsatisfactory.

### Comparative Example 5

With reference to the composition of Example Ill in Patent Literature 4 (WO 2014/184082), the component [c] was excluded from the composition of Example 1, and the blending amount of the component [d] was decreased as compared to that in Example 1. The thermosetting epoxy resin composition had a difference of 78° C. between the curing temperature and the gelation temperature, which was unsatisfactory, and a normalized bending deflection of 4.6 mm, which was unsatisfactory.

### Comparative Example 6

With reference to the composition of Example 2 in Patent Literature 1 (JP 2008-222983 A), the component [a] was changed to a species containing more hydroxyl groups, and the component [b] was changed to another species, and the blending amount of the component [c] was decreased, and the component [d] changed to an amine, and the H/E was increased to 4.1, as compared to those in Example 1. The thermosetting epoxy resin composition had a difference of 92° C. between the curing temperature and the gelation temperature, which was unsatisfactory, and a normalized bending deflection of 4.0 mm, which was unsatisfactory.

TABLE 1

| | | | Ex. | Ex. | Ex. | Ex. | Ex. | Ex. | Ex. | Ex. | Ex. | Ex. | Ex. |
|---|---|---|---|---|---|---|---|---|---|---|---|---|---|
| | | | 1 | 2 | 3 | 4 | 5 | 6 | 7 | 8 | 9 | 10 | 11 |
| Compostion | [a] Epoxy | “jER” 828 | 100 | 100 | 100 | 100 | 70 | 30 | | | | | |
| | resin | “Epotohto” YD-8125 | | | | | 30 | 70 | 100 | 100 | 100 | 100 | 100 |
| | | “ARALDITE” MY721 | | | | | | | | | | | |
| | | “jER” 1002 | | | | | | | | | | | |
| | [b] | “Lupranate” M20S | 71 | 71 | 71 | 71 | 73 | 76 | 78 | 78 | 78 | 78 | 78 |
| | Isocyanate | “Lupranate” MI | | | | | | | | | | | |
| | curing | “Coronate” L | | | | | | | | | | | |
| | agent | | | | | | | | | | | | |
| | [c] | Chlorophenyl isocyanate | 5 | 5 | | | | | | | | | |
| | Hydroxyl | Toluenesulfonyl isocyanate | | | 5 | | 5 | 5 | 5 | 0.5 | 1 | 15 | 20 |
| | group | Chloroacetic anhydride | | | | 5 | | | | | | | |
| | capping | | | | | | | | | | | | |
| | agent | | | | | | | | | | | | |
| | [d] Epoxy | “DBU” | 1 | | | | | | | | | | |
| | curing | “TBD”/dichloroacetic acid | | 1 | 1 | 1 | 1 | 1 | 1 | 1 | 1 | 1 | 1 |
| | catalyst | 1-Butyl-3-methylimidazolium | | | | | | | | | | | |
| | | bromide | | | | | | | | | | | |
| | | Tetrabutylammonium nitrate | | | | | | | | | | | |
| | | Tetrabutylammonium bromide | | | | | | | | | | | |
| | | Tetrabutylammonium chloride | | | | | | | | | | | |
| | | “TBP-BB” | | | | | | | | | | | |
| | | Dibutylamine | | | | | | | | | | | |

| | | | | | | | | | | | | |
|---|---|---|---|---|---|---|---|---|---|---|---|---|
| Properties of | Stoichiometric ratio of [b] to [a], H/E | 1 | 1 | 1 | 1 | 1 | 1 | 1 | 1 | 1 | 1 | 1 |
| each | Amount of hydroxyl groups contained in [a] | 0.30 | 0.30 | 0.30 | 0.30 | 0.24 | 0.16 | 0.10 | 0.10 | 0.10 | 0.10 | 0.10 |
| component | [mmol/g] | | | | | | | | | | | |
| | Exothermic peak temperature Tb of the | 95 | 95 | 95 | 95 | 95 | 95 | 95 | 95 | 95 | 95 | 95 |
| | reaction of [b] [° C.] | | | | | | | | | | | |
| | Exothermic peak temperature Tc of the | 75 | 75 | 45 | 85 | 45 | 45 | 45 | 45 | 45 | 45 | 45 |
| | reaction of [c] [° C.] | | | | | | | | | | | |
| | Tb-Tc [° C.] | 20 | 20 | 50 | 10 | 50 | 50 | 50 | 50 | 50 | 50 | 50 |
| Properties of | Viscosity at 25° C. [Pa · s] | 8 | 5 | 5 | 4 | 3 | 2 | 1.2 | 1 | 1 | 0.6 | 0.4 |
| each epoxy | Gelation temperature [° C.] | 139 | 145 | 152 | 144 | 162 | 171 | 181 | 158 | 166 | 201 | 208 |
| resin | Curing temperature [° C.] | 190 | 200 | 200 | 205 | 200 | 200 | 200 | 210 | 205 | 220 | 240 |
| composition | Difference between gelation and curing | 51 | 55 | 48 | 61 | 38 | 29 | 19 | 52 | 39 | 19 | 32 |
| | temperatures [° C.] | | | | | | | | | | | |
| Properties of | Glass transition temperature of molded | 181 | 175 | 174 | 168 | 175 | 178 | 180 | 179 | 180 | 166 | 156 |
| each molded | articles [° C.] | | | | | | | | | | | |
| article | Glass transition temperature after wet-heat | 167 | 163 | 162 | 157 | 166 | 171 | 174 | 169 | 172 | 156 | 143 |
| | treatment of molded articles [° C.] | | | | | | | | | | | |
| | Bending deflection of molded articles [mm] | 6 | 7 | 8 | 7 | 9 | 10 | 11 | 7 | 8 | 12 | 11 |
| | Normalized bending deflection of molded | 8.4 | 8.8 | 9.7 | 8.0 | 11.2 | 12.9 | 14.4 | 9.7 | 11.1 | 12.8 | 10.0 |
| | articles [mm] | | | | | | | | | | | |

TABLE 2

| | | | Ex. | Ex. | Ex. | Ex. | Ex. | Ex. | Ex. | Ex. | Ex. | Ex. | Ex. | Ex. |
|---|---|---|---|---|---|---|---|---|---|---|---|---|---|---|
| | | | 12 | 13 | 14 | 15 | 16 | 17 | 18 | 19 | 20 | 21 | 22 | 23 |
| Composition | [a] Epoxy | “jER” 828 | | | | | | | | | | | | |
| | resin | “Epotohto” YD-8125 | 100 | 100 | 100 | 100 | 50 | 100 | 100 | 100 | 100 | 100 | 100 | 100 |
| | | “ARALDITE” MY721 | | | | | 50 | | | | | | | |
| | | “jER” 1002 | | | | | | | | | | | | |
| | [b] | “Lupranate” M20S | 39 | 59 | 117 | 156 | | 78 | 78 | 78 | 78 | 78 | 59 | 117 |
| | Isocyanate | “Lupranate” MI | | | | | 126 | | | | | | | |
| | curing | “Coronate” L | | | | | | | | | | | | |
| | agent | | | | | | | | | | | | | |
| | [c] | Chlorophenyl isocyanate | | | | | | | | | | | | |
| | Hydroxyl | Toluenesulfonyl isocyanate | 5 | 5 | 5 | 5 | 5 | 5 | 5 | 5 | 5 | 5 | 5 | 5 |
| | group | Chloroacetic anhydride | | | | | | | | | | | | |
| | capping | | | | | | | | | | | | | |
| | agent | | | | | | | | | | | | | |
| | [d] Epoxy | “DBU” | | | | | | | | | | | | |
| | curing | ″TBD″/dichloroacetic acid | 1 | 1 | 1 | 1 | 1 | | | | | | | |
| | catalyst | 1-Butyl-3- | | | | | | 1 | | | | | | |
| | | methylimidazolium bromide | | | | | | | | | | | | |
| | | Tetrabutylammonium nitrate | | | | | | | 1 | | | | | |
| | | Tetrabutylammonium | | | | | | | | 1 | | | 1 | 1 |
| | | bromide | | | | | | | | | | | | |
| | | Tetrabutylammonium | | | | | | | | | 1 | | | |
| | | chloride | | | | | | | | | | | | |
| | | “TBP-BB” | | | | | | | | | | 1 | | |
| | | Dibutylamine | | | | | | | | | | | | |

| Properties of | Stoichiometric ratio of [b] to [a], H/E | 0.5 | 0.75 | 1.5 | 2 | 1 | 1 | 1 | 1 | 1 | 1 | 0.75 | 1.5 |
|---|---|---|---|---|---|---|---|---|---|---|---|---|---|
| each | Amount of hydroxyl groups contained in [a] | 0.10 | 0.10 | 0.10 | 0.10 | 0.07 | 0.10 | 0.10 | 0.10 | 0.10 | 0.10 | 0.10 | 0.10 |
| component | [mmol/g] | | | | | | | | | | | | |
| | Exothermic peak temperature Tb of the | 95 | 95 | 95 | 95 | 95 | 95 | 95 | 95 | 95 | 95 | 95 | 95 |
| | reaction of [b] [° C.] | | | | | | | | | | | | |
| | Exothermic peak temperature Tc of the | 45 | 45 | 45 | 45 | 45 | 45 | 45 | 45 | 45 | 45 | 45 | 45 |
| | reaction of [c] [° C.] | | | | | | | | | | | | |
| | Tb-Tc [° C.] | 50 | 50 | 50 | 50 | 50 | 50 | 50 | 50 | 50 | 50 | 50 | 50 |
| Properties of | Viscosity at 25° C. [Pa · s] | 3 | 2 | 0.5 | 0.3 | 0.2 | 1.2 | 1.2 | 1.2 | 1.2 | 1.2 | 2 | 0.5 |
| each epoxy | Gelation temperature [° C.] | 167 | 173 | 195 | 200 | 192 | 192 | 203 | 179 | 191 | 178 | 171 | 183 |
| resin | Curing temperature [° C.] | 210 | 205 | 215 | 230 | 210 | 254 | 265 | 228 | 239 | 227 | 233 | 243 |
| composition | Difference between gelation and curing | 43 | 32 | 20 | 30 | 18 | 62 | 62 | 49 | 48 | 49 | 62 | 60 |
| | temperatures [° C.] | | | | | | | | | | | | |
| Properties of | Glass transition temperature of molded | 148 | 168 | 187 | 180 | 206 | 178 | 180 | 182 | 179 | 179 | 170 | 189 |
| each molded | articles [° C.] | | | | | | | | | | | | |
| article | Glass transition temperature after wet-heat | 139 | 158 | 179 | 170 | 195 | 171 | 173 | 177 | 173 | 174 | 161 | 182 |
| | treatment of molded articles [° C.] | | | | | | | | | | | | |
| | Bending deflection of molded articles [mm] | 10 | 11 | 9 | 5 | 8 | 9 | 7 | 13 | 11 | 12 | 13 | 11 |
| | Normalized bending deflection of molded | 8.5 | 12.1 | 13.1 | 7.8 | 14.3 | 11.9 | 10.2 | 16.8 | 14.2 | 15.4 | 14.5 | 15.5 |

articles [mm]

TABLE 3

| | | | Ex. | Ex. | Ex. | Ex. | Ex. | Ex. | Ex |
|---|---|---|---|---|---|---|---|---|---|
| | | | 24 | 25 | 26 | 27 | 28 | 29 | 30 |
| Composition | [a] Epoxy resin | “Epotohto” YD-8125 | 100 | 100 | 100 | 100 | 100 | 100 | 100 |
| | [b] Isocyanate | “Lupranate” M20S | 78 | 78 | 78 | 59 | 117 | 59 | 117 |
| | curing agent | | | | | | | | |
| | [c] Hydroxyl | Toluenesulfonyl isocyanate | 5 | 5 | 5 | 5 | 5 | 5 | 5 |
| | group capping | | | | | | | | |
| | agent | | | | | | | | |
| | [d] Epoxy | Calcium iodide | 1 | | | | | | |
| | curing catalyst | Lithium bromide | | 1 | | 1 | 1 | | |
| | | Lithium chloride | | | 1 | | | 1 | 1 |

| | | | | | | | | |
|---|---|---|---|---|---|---|---|---|
| Properties of | Stoichiometric ratio of [b] to [a], H/E | 1 | 1 | 1 | 0.75 | 1.5 | 0.75 | 1.5 |
| each | Amount of hydroxyl groups contained in [a] | 0.10 | 0.10 | 0.10 | 0.10 | 0.10 | 0.10 | 0.10 |
| component | [mmol/g] | | | | | | | |
| | Exothermic peak temperature Tb of the | 95 | 95 | 95 | 95 | 95 | 95 | 95 |
| | reaction of [b] [° C.] | | | | | | | |
| | Exothermic peak temperature Tc of the | 45 | 45 | 45 | 45 | 45 | 45 | 45 |
| | reaction of [c] [° C.] | | | | | | | |
| | Tb-Tc [C] | 50 | 50 | 50 | 50 | 50 | 50 | 50 |
| Properties of | Viscosity at 25° C. [Pa · s] | 1.1 | 1.1 | 1.2 | 1.6 | 0.7 | 1.5 | 1 |
| each epoxy | Gelation temperature [° C.] | 150 | 135 | 148 | 135 | 133 | 154 | 151 |
| resin | Curing temperature [° C.] | 179 | 147 | 165 | 163 | 152 | 178 | 170 |
| composition | Difference between gelation and curing | 29 | 12 | 17 | 28 | 19 | 24 | 19 |
| | temperatures [° C.] | | | | | | | |
| Properties of | Glass transition temperature of molded articles | 156 | 170 | 172 | 173 | 179 | 159 | 163 |
| each molded | Glass transition temperature after wet-heat | 152 | 160 | 161 | 161 | 166 | 148 | 150 |
| article | treatment of molded articles [° C.] | | | | | | | |
| | Bending deflection of molded articles [mm] | 9 | 7 | 7.5 | 7 | 8.5 | 8 | 9 |
| | Normalized bending deflection of molded | 9.3 | 8.4 | 9.0 | 8.5 | 10.7 | 7.7 | 9.0 |
| | articles [mm] | | | | | | | |

TABLE 4

| | | | Comp. | Comp. | Comp. | Comp. | Comp. | Comp. |
|---|---|---|---|---|---|---|---|---|
| | | | Ex. 1 | Ex. 2 | Ex. 3 | Ex. 4 | Ex. 5 | Ex. 6 |
| Composition | [a] Epoxy | “jER” 828 | 100 | 100 | | | 100 | |
| | resin | “Epotohto” YD-8125 | | | 100 | 100 | | |
| | | “ARALDITE” MY721 | | | | | | |
| | | “jER” 1002 | | | | | | 100 |
| | [b] | “Lupranate” M20S | 71 | 71 | 23 | 195 | 71 | |
| | Isocyanate | “Lupranate” MI | | | | | | |
| | curing agent | “Coronate” L | | | | | | 200 |
| | [c] Hydroxyl | Chlorophenyl isocyanate | | | | | | |
| | group | Toluenesulfonyl isocyanate | | 5 | 5 | 5 | | 0.4 |
| | capping | Chloroacetic anhydride | | | | | | |
| | agent | | | | | | | |
| | [d] Epoxy | “DBU” | | | | | 0.15 | |
| | curing | “TBD”/dichloroacetic acid | 1 | | 1 | 1 | | |
| | catalyst | 1-Butyl-3-methylimidazolium | | | | | | |
| | | bromide | | | | | | |
| | | Tetrabutylammonium nitrate | | | | | | |
| | | Tetrabutylammonium bromide | | | | | | |
| | | Tetrabutylammonium chloride | | | | | | |
| | | “TBP-BB” | | | | | | |
| | | Dibutylamine | | | | | | 0.4 |

| | | | | | | | |
|---|---|---|---|---|---|---|---|
| Properties of | Stoichiometric ratio of [b] to [a], H/E | 1 | 1 | 0.3 | 2.5 | 1 | 4.1 |
| each | Amount of hydroxyl groups contained in [a] | 0.30 | 0.30 | 0.30 | 0.30 | 0.30 | 2.6 |
| component | [mmol/g] | | | | | | |
| | Exothermic peak temperature Tb of the reaction | 95 | 95 | 95 | 95 | 95 | 120 |
| | of [b] [° C.] | | | | | | |
| | Exothermic peak temperature Tc of the reaction | — | 45 | 45 | 45 | — | 45 |
| | of [c] [° C.] | | | | | | |
| | Tb-Tc [° C.] | — | 50 | 50 | 50 | — | 75 |
| Properties of | Viscosity at 25° C. [Pa · s] | >10 | 5 | 4 | 0.2 | >10 | >10 |
| each epoxy | Gelation temperature [° C.] | 141 | — | 164 | 201 | 132 | 128 |
| resin | Curing temperature [° C.] | 220 | — | 220 | 245 | 210 | 220 |
| composition | Difference between gelation and curing | 79 | 1 | 56 | 44 | 78 | 92 |
| | temperatures [° C.] | | | | | | |
| Properties of | Glass transition temperature of molded articles | 167 | — | 131 | 171 | 162 | 131 |
| each molded | [° C.] | | | | | | |
| article | Glass transition temperature after wet-heat | 152 | — | 118 | 159 | 147 | 114 |
| | treatment of molded articles [° C.] | | | | | | |
| | Bending deflection of molded articles [mm] | 4 | — | 7 | 3 | 5 | 9 |
| | Normalized bending deflection of molded articles | 4.3 | — | 2.5 | 4.3 | 4.6 | 4.0 |
| | [mm] | | | | | | |

Examples 31 to 37 and Comparative Example 7 are as Follows (Including Table 5).

### (12) Raw Materials for Thermosetting Epoxy Resin Compositions

Raw materials used to obtain thermosetting epoxy resin compositions of the examples are same as the raw materials for thermosetting epoxy resin compositions described in the above subsection (1).

### (13) Production of Carbon Fibers

The carbon fibers [I] to [V] were produced according to the following production methods.

### <Carbon Fiber [I]>

A copolymer comprising 99.4% by mole of acrylonitrile and 0.6% by mole of methacrylic acid was used to produce acrylic precursor fibers with a single-fiber fineness of 0.08 tex and a filament count of 12000 by a dry-wet spinning method.

The precursor fibers were heated in the air at a temperature of 240° C. to 280° C. with applying a draw ratio of 1.05 to convert the precursor fibers to flame proofing fibers and were further heated in a nitrogen atmosphere at a temperature ramp rate of 200° C./min in the temperature range from 300° C. to 900° C. with applying a draw ratio of 1.10, and the temperature was then increased up to 1400° C. for calcination and promotion of carbonization. In the obtained carbon fibers, the fiber areal weight was 0.50 g/m, and the density was 1.80 g/cm³.

Subsequently, the carbon fibers were treated by electrolytic oxidation, in which an aqueous solution of ammonium bicarbonate at a concentration of 1.0 mol/L was used as an electrolyte and the quantity of electricity was 3 C/g·bath. After the electrolytic oxidation, the resulting carbon fibers were washed with water and then dried in air at 150° C. to obtain carbon fibers [I].

The carbon fibers [I] had a surface oxygen concentration O/C of 0.08, an average fiber diameter of 5.5 μm, and a substantially perfect circular cross-section with a r/R ratio of 0.95.

### <Carbon Fiber [II]>

Carbon fibers [II] were produced and obtained under the same conditions as those for the carbon fibers [I], except that the quantity of electricity was altered to 30 C/g·bath for the electrolytic oxidation.

The carbon fibers [II] had a surface oxygen concentration O/C of 0.18, an average fiber diameter of 5.5 μm, and a substantially perfect circular cross-section with a r/R ratio of 0.95.

### <Carbon Fiber [III]>

Carbon fibers [III] were produced and obtained under the same conditions as those for the carbon fibers [I], except that the quantity of electricity was altered to 1 C/g·bath for the electrolytic oxidation.

The carbon fibers [III] had a surface oxygen concentration O/C of 0.03, an average fiber diameter of 5.5 μm, and a substantially perfect circular cross-section with a r/R ratio of 0.95.

### <Carbon Fiber [IV]>

Carbon fibers [IV] were produced and obtained under the same conditions as those for the carbon fibers [I], except that the quantity of electricity was altered to 100 C/g·bath for the electrolytic oxidation.

The carbon fibers [IV] had a surface oxygen concentration O/C of 0.22, an average fiber diameter of 5.5 μm, and a substantially perfect circular cross-section with a r/R ratio of 0.95.

### <Carbon Fiber [V]>

Carbon fibers [V] were produced and obtained under the same conditions as those for the carbon fibers [I], except that the spinning method for the acrylic precursor fibers was replaced by a wet spinning method and the obtained acrylic precursor fibers had a single-fiber fineness of 0.09 tex. In the obtained carbon fibers, the fiber areal weight was 0.50 g/m, and the density was 1.80 g/cm³.

The carbon fibers [V] had a surface oxygen concentration O/C of 0.05, an average fiber diameter of 5.4 μm, and a flattened cross-section with a r/R ratio of 0.8.

### (14) Production of Carbon Fiber Woven Fabrics

The carbon fibers obtained through the above subsection (13) “Production of carbon fibers” were used as warps and wefts to produce plain carbon fiber woven fabrics with an areal weight of 190 g/m².

### (15) Preparation of Thermosetting Epoxy Resin Compositions

According to each of the compositions (in mass ratio) shown in Table 5, epoxy resin compositions were prepared in the same manner as in the above subsection (5) “Preparation of thermosetting epoxy resin compositions”.

### (16) Production of Fiber-Reinforced Composite Materials

From a carbon fiber woven fabric produced as described in the above subsection (14) “Production of carbon fiber woven fabrics,” 10 pieces of the woven fabric with a size of 400 mm×400 mm were cut and laminated on one another in a mold with a plate cavity and then compressed in the mold by a pressing machine. For this process, the thickness of the cavity was configured to allow each fiber-reinforced composite material to have a fiber volume content of 40%. Subsequently, a vacuum pump was used to reduce the pressure inside the mold to the atmospheric pressure −0.1 MPa, and a thermosetting epoxy resin composition prepared as described in the above subsection (15) “Preparation of thermosetting epoxy resin compositions” was injected with a pressure of 0.2 MPa into the mold by using a resin injector. Then, the thermoplastic epoxy resin composition was heated at a rate of 10° C./min from a normal temperature to a curing temperature described in Table 5, followed by immediate demolding to produce a fiber-reinforced composite material.

(17) Measurement of In-Plane Shear Strength and Shear Modulus after Water Imbibition

Each of the fiber-reinforced composite materials produced as described in the above subsection (16) “Production of fiber-reinforced composite materials” was analyzed by performing the ±45° tensile test in accordance with JIS K 7019: 1999 to determine the in-plane shear strength. Additionally, each of the fiber-reinforced composite materials produced as described in the above subsection (16) “Production of fiber-reinforced composite materials” was also immersed in hot water at 72° C. for 14 days and then analyzed by the same tensile test as used for the determination of the in-plane shear strength to determine the in-plane shear modulus after water imbibition.

(18) Measurement of the Impregnating Property of Thermosetting Epoxy Resin Compositions into Reinforcing Fibers

The impregnating property during the resin injection process for the above subsection (16) “Production of fiber-reinforced composite materials” was evaluated according to the following four-grade system based on the content of voids in a fiber-reinforced composite material. The impregnating property was evaluated as “Good” when the content of voids in a fiber-reinforced composite material accounts for less than 0.5%, and the impregnating property was evaluated as “Fair” when the content of voids in a fiber-reinforced composite material accounts for 0.5% or more and less than 1%, and the impregnating property was evaluated as “Bad” when the content of voids in a fiber-reinforced composite material accounts for 1% or more.

The content of voids in a fiber-reinforced composite material was calculated from the void area ratio measured for the fiber-reinforced composite material by observing a finely polished cross-section of the fiber-reinforced composite material under a reflected optical microscope.

### Example 31

A thermosetting epoxy resin was prepared as described in the above subsection (15) “Preparation of thermosetting epoxy resin compositions” and then used as described in the above subsection (16) “Production of fiber-reinforced composite materials” to produce a fiber-reinforced composite material. The fiber-reinforced composite material had an in-plane shear strength of 205 MPa, which was excellent, and an in-plane shear modulus after water imbibition of 6.3 GPa, which was excellent. In addition, the impregnating property was evaluated as good.

### Example 32

The component [c] was changed from that used in Example 31 to a high-activity species. The fiber-reinforced composite material had an in-plane shear strength of 210 MPa, which was excellent, and an in-plane shear modulus after water imbibition of 6.4 GPa, which was particularly excellent. In addition, the impregnating property was evaluated as good.

### Example 33

The component [c] was changed from that used in Example 31 to a low-activity species. The fiber-reinforced composite material had an in-plane shear strength of 205 MPa, which was excellent, and an in-plane shear modulus after water imbibition of 6.2 GPa, which was acceptable. In addition, the impregnating property was evaluated as good.

### Example 34

The reinforcing fiber in Example 32 was changed to another reinforcing fiber. The fiber-reinforced composite material had an in-plane shear strength of 215 MPa, which was particularly excellent, and an in-plane shear modulus after water imbibition of 6.4 GPa, which was particularly excellent. In addition, the impregnating property was evaluated as good.

### Example 35

The reinforcing fiber in Example 32 was changed to another reinforcing fiber. The fiber-reinforced composite material had an in-plane shear strength of 200 MPa, which was acceptable, and an in-plane shear modulus after water imbibition of 6.3 GPa, which was excellent. In addition, the impregnating property was evaluated as good.

### Example 36

The reinforcing fiber in Example 32 was changed to another reinforcing fiber. The fiber-reinforced composite material had an in-plane shear strength of 220 MPa, which was particularly excellent, and an in-plane shear modulus after water imbibition of 6.4 GPa, which was particularly excellent. In addition, the impregnating property was evaluated as good.

### Example 37

The reinforcing fiber in Example 32 was changed to another reinforcing fiber. The fiber-reinforced composite material had an in-plane shear strength of 200 MPa, which was acceptable, and an in-plane shear modulus after water imbibition of 6.1 GPa, which was acceptable. In addition, the impregnating property was evaluated as fair.

### Comparative Example 7

The component [c] was excluded from the composition of Example 31. The fiber-reinforced composite material had an in-plane shear strength of 190 MPa, which was poor, and an in-plane shear modulus after water imbibition of 5.9 GPa, which was poor. In addition, many voids were found in the fiber-reinforced composite material, and the impregnating property was evaluated as bad.

TABLE 5

| | | | Ex. | Ex. | Ex. | Ex. | Ex | Ex. | Ex. | Comp. |
|---|---|---|---|---|---|---|---|---|---|---|
| | | | 31 | 32 | 33 | 34 | 35 | 36 | 37 | Ex. 7 |
| Composition | [a] Epoxy resin | “jER” 828 | 100 | 100 | 100 | 100 | 100 | 100 | 100 | 100 |
| | [b] Isocyanate | “Lupranate” M20S | 71 | 71 | 71 | 71 | 71 | 71 | 71 | 71 |
| | curing agent | | | | | | | | | |
| | [c] Hydroxyl | Chlorophenyl isocyanate | 5 | | | | | | | |
| | group capping | Toluenesulfonyl isocyanate | | 5 | | 5 | 5 | 5 | 5 | |
| | agent | Chloroacetic anhydride | | | 5 | | | | | |
| | [d] Epoxy curing | “TBD”/dichloroacetic acid | 1 | 1 | 1 | 1 | 1 | 1 | 1 | 1 |
| | catalyst | | | | | | | | | |

| | | | | | | | | |
|---|---|---|---|---|---|---|---|---|
| Carbon fiber | [I] | [I] | [I] | [II] | [III] | [IV] | [V] | [I] |
| Curing temperature [° C.] | 200 | 200 | 205 | 200 | 200 | 200 | 200 | 220 |
| In-plane shear strength [MPa] | 205 | 210 | 205 | 215 | 200 | 220 | 200 | 190 |
| In-plane shear modulus after water imbibition [GPa] | 6.3 | 6.4 | 6.2 | 6.4 | 6.3 | 6.4 | 6.1 | 5.9 |
| Impregnation property | Good | Good | Good | Good | Good | Good | Fair | Bad |

Examples 32, 38 to 49 and Comparative Example 8 are as follows (including Tables 6 and 7).

### (19) Raw Materials for Thermosetting Epoxy Resin Compositions

Raw materials used to obtain thermosetting epoxy resin compositions of the examples are same as the raw materials for thermosetting epoxy resin compositions described in the above subsection (1).

### (20) Production of Carbon Fibers

The carbon fibers [I] were produced as described in the above subsection (13) “Production of carbon fibers”.

### (21) Application of a Sizing Agent to Carbon Fibers

The following components were blended to prepare sizing agents according to the composition shown in Table 6. The resulting sizing agents were diluted with a solvent to produce sizing agent solutions, and the carbon fibers produced in the above subsection (20) “Production of carbon fibers” were immersed in the sizing agent solutions and then dried by heating to obtain carbon fibers coated with any of the sizing agents at a coating amount of shown in Table 7.

### <Thermoplastic Resin>

PEO-1 (polyethylene oxide, manufactured by Sumitomo Seika Chemicals Co., Ltd.)
AQ nylon P-70 (water soluble nylon, manufactured by Toray Industries, Inc.)

### <Aromatic Epoxy Resin>

“jER (registered trademark)” 828 (liquid bisphenol A-type epoxy resin, manufactured by Mitsubishi Chemical Co.)
“jER (registered trademark)” 834 (solid bisphenol A-type epoxy resin, manufactured by Mitsubishi Chemical Co.)

### <Other>

“DENACOL (registered trademark)” EX-614 (sorbitol-type epoxy resin, manufactured by Nagase ChemteX Co.)

### (22) Production of Carbon Fiber Woven Fabrics

The carbon fibers obtained through the above subsection (20) “Production of carbon fibers” and (21) “Application of a sizing agent to carbon fibers” were used as warps and wefts to produce plain carbon fiber woven fabrics with an areal weight of 190 g/m².

### (23) Preparation of Thermosetting Epoxy Resin Compositions

According to each of the compositions (in mass ratio) shown in Table 7, epoxy resin compositions were prepared in the same manner as in the above subsection (5) “Preparation of thermosetting epoxy resin compositions”.

### (24) Production of Fiber-Reinforced Composite Materials

The carbon fiber woven fabrics produced as described in the above subsection (22) “Production of carbon fiber woven fabrics” and the thermosetting epoxy resin compositions prepared as described in the above subsection (23) “Preparation of thermosetting epoxy resin compositions” were used to produce fiber-reinforced composite material, similarly to the above subsection (16) “Production of fiber-reinforced composite materials”.

(25) Measurement of In-Plane Shear Strength and Shear Modulus after Water Imbibition

The fiber-reinforced composite materials produced as described in the above subsection (24) “Production of fiber-reinforced composite materials” were analyzed to determine the in-plane shear strength and the in-plane shear modulus after water imbibition, similarly to the above subsection (17) “Measurement of in-plane shear strength and shear modulus after water imbibition”.

### (26) Measurement of Tensile Strength

The fiber-reinforced composite materials produced as described in the above subsection (24) “Production of fiber-reinforced composite materials” were analyzed by performing the tensile test in accordance with JIS K 7164: 2005 to determine the tensile strength.

(27) Measurement of the Impregnating Property of Thermosetting Epoxy Resin Compositions into Reinforcing Fibers

The impregnating property during the resin injection process for the above subsection (24) “Production of fiber-reinforced composite materials” was evaluated similarly to the above subsection (18) “Measurement of the impregnating property of thermosetting epoxy resin compositions into reinforcing fibers”.

### Example 32

The in-plane shear strength, in-plane shear modulus after water imbibition, and impregnating property were as described above, and the tensile strength was 1330 MPa, which was acceptable.

### Example 38

A thermosetting epoxy resin was prepared as described in the above subsection (23) “Preparation of thermosetting epoxy resin compositions” and then used as described in the above subsection (24) “Production of fiber-reinforced composite materials” to produce a fiber-reinforced composite material. The fiber-reinforced composite material had an in-plane shear strength of 210 MPa, which was excellent, and an in-plane shear modulus after water imbibition of 6.5 GPa, which was particularly excellent, and a tensile strength of 1340 MPa, which is acceptable. In addition, the impregnating property was evaluated as good.

### Example 39

The amount of a sizing agent applied was altered from that used in Example 38. The fiber-reinforced composite material had an in-plane shear strength of 220 MPa, which was particularly excellent, and an in-plane shear modulus after water imbibition of 6.5 GPa, which was particularly excellent, and a tensile strength of 1350 MPa, which was excellent. In addition, the impregnating property was evaluated as good.

### Example 40

The amount of a sizing agent applied was altered from that used in Example 38. The fiber-reinforced composite material had an in-plane shear strength of 220 MPa, which was particularly excellent, and an in-plane shear modulus after water imbibition of 6.4 GPa, which was particularly excellent, and a tensile strength of 1360 MPa, which was excellent. In addition, the impregnating property was evaluated as good.

### Example 41

The amount of a sizing agent applied was altered from that used in Example 38. The fiber-reinforced composite material had an in-plane shear strength of 210 MPa, which was excellent, and an in-plane shear modulus after water imbibition of 6.3 GPa, which was excellent, and a tensile strength of 1340 MPa, which was acceptable. In addition, the impregnating property was evaluated as good.

### Example 42

The composition of a sizing agent was altered from that used in Example 39. The fiber-reinforced composite material had an in-plane shear strength of 220 MPa, which was particularly excellent, and an in-plane shear modulus after water imbibition of 6.6 GPa, which was particularly excellent, and a tensile strength of 1350 MPa, which was excellent. In addition, the impregnating property was evaluated as good.

### Example 43

The composition of a sizing agent was altered from that used in Example 39. The fiber-reinforced composite material had an in-plane shear strength of 230 MPa, which was particularly excellent, and an in-plane shear modulus after water imbibition of 6.7 GPa, which was particularly excellent, and a tensile strength of 1350 MPa, which was excellent. In addition, the impregnating property was evaluated as good.

### Example 44

The composition of a sizing agent was altered from that used in Example 39. The fiber-reinforced composite material had an in-plane shear strength of 220 MPa, which was particularly excellent, and an in-plane shear modulus after water imbibition of 6.7 GPa, which was particularly excellent, and a tensile strength of 1420 MPa, which was particularly excellent. In addition, the impregnating property was evaluated as good.

### Example 45

The composition of a sizing agent was altered from that used in Example 39. The fiber-reinforced composite material had an in-plane shear strength of 220 MPa, which was particularly excellent, and an in-plane shear modulus after water imbibition of 6.7 GPa, which was particularly excellent, and a tensile strength of 1450 MPa, which was particularly excellent. In addition, the impregnating property was evaluated as good.

### Example 46

The composition of a sizing agent was altered from that used in Example 39. The fiber-reinforced composite material had an in-plane shear strength of 210 MPa, which was excellent, and an in-plane shear modulus after water imbibition of 6.6 GPa, which was particularly excellent, and a tensile strength of 1450 MPa, which was particularly excellent. In addition, the impregnating property was evaluated as good.

### Example 47

The composition of a sizing agent was altered from that used in Example 39. The fiber-reinforced composite material had an in-plane shear strength of 210 MPa, which was excellent, and an in-plane shear modulus after water imbibition of 6.4 GPa, which was particularly excellent, and a tensile strength of 1430 MPa, which was particularly excellent. In addition, the impregnating property was evaluated as good.

### Example 48

The composition of a sizing agent was altered from that used in Example 39. The fiber-reinforced composite material had an in-plane shear strength of 210 MPa, which was excellent, and an in-plane shear modulus after water imbibition of 6.5 GPa, which was particularly excellent, and a tensile strength of 1320 MPa, which was acceptable. In addition, the impregnating property was evaluated as good.

### Example 49

The composition of a sizing agent was altered from that used in Example 39. The fiber-reinforced composite material had an in-plane shear strength of 220 MPa, which was particularly excellent, and an in-plane shear modulus after water imbibition of 6.3 GPa, which was excellent, and a tensile strength of 1340 MPa, which was acceptable. In addition, the impregnating property was evaluated as good.

### Comparative Example 8

The component [c] was excluded from the composition of Example 39. The fiber-reinforced composite material had an in-plane shear strength of 200 MPa, which was poor, and an in-plane shear modulus after water imbibition of 6.0 GPa, which was poor, and a tensile strength of 1310 MPa, which was poor. In addition, many voids were found in the fiber-reinforced composite material, and the impregnating property was evaluated as bad.

TABLE 6

| Composition of each sizing agent | | [i] | [ii] | [iii] | [iv] | [v] | [vi] | [vii] | [viii] | [ix] |
|---|---|---|---|---|---|---|---|---|---|---|
| Thermoplastic resin | PEO-1 | | | | | | 85 | 100 | | |
| | AQ Nylon P-70 | 15 | 15 | 15 | 30 | 60 | | | | |
| Aromatic epoxy | “jER” 828 | | | 60 | 30 | 40 | 15 | | | |
| | “jER” 834 | | 15 | | | | | | 100 | 40 |
| Other | “DENACOL” EX-614 | 85 | 70 | 25 | 40 | | | | | 60 |

TABLE 7

| | | | Ex. | Ex. | Ex. | Ex. | Ex. | Ex. | Ex. | Ex. | Ex. | Ex. | Ex. | Ex. | Ex. | Comp. |
|---|---|---|---|---|---|---|---|---|---|---|---|---|---|---|---|---|
| | | | 32 | 38 | 39 | 40 | 41 | 42 | 43 | 44 | 45 | 46 | 47 | 48 | 49 | Ex. 8 |
| Composition | [a] Epoxy | “jER” 828 | 100 | 100 | 100 | 100 | 100 | 100 | 100 | 100 | 100 | 100 | 100 | 100 | 100 | 100 |
| | resin | | | | | | | | | | | | | | | |
| | [b] | “Lupranate” | 71 | 71 | 71 | 71 | 71 | 71 | 71 | 71 | 71 | 71 | 71 | 71 | 71 | 71 |
| | Isocyanate | M20S | | | | | | | | | | | | | | |
| | curing agent | | | | | | | | | | | | | | | |
| | [c] | Toluenesulfonyl | 5 | 5 | 5 | 5 | 5 | 5 | 5 | 5 | 5 | 5 | 5 | 5 | 5 | |
| | Hydroxyl | isocyanate | | | | | | | | | | | | | | |
| | group | | | | | | | | | | | | | | | |
| | capping | | | | | | | | | | | | | | | |
| | agent | | | | | | | | | | | | | | | |
| | [d] Epoxy | “TBD”/ | 1 | 1 | 1 | 1 | 1 | 1 | 1 | 1 | 1 | 1 | 1 | 1 | 1 | 1 |
| | curing | dichloroacetic | | | | | | | | | | | | | | |
| | catalyst | acid | | | | | | | | | | | | | | |

| | | | | | | | | | | | | | | |
|---|---|---|---|---|---|---|---|---|---|---|---|---|---|---|
| Carbon fiber | [I] | [I] | [I] | [I] | [I] | [I] | [I] | [I] | [I] | [I] | [I] | [I] | [I] | [I] |
| Composition of each sizing agent | — | [i] | [i] | [i] | [i] | [ii] | [iii] | [iv] | [v] | [vi] | [vii] | [viii] | [ix] | [i] |
| Amount of each applied sizing agent | — | 0.1 | 1.0 | 1.5 | 2.0 | 1.0 | 1.0 | 1.0 | 1.0 | 1.0 | 1.0 | 1.0 | 1.0 | 1.0 |
| [% by mass] | | | | | | | | | | | | | | |
| Curing temperature [° C.] | 200 | 200 | 200 | 200 | 200 | 200 | 200 | 200 | 200 | 200 | 200 | 200 | 200 | 220 |
| In-plane shear strength [MPa] | 210 | 210 | 220 | 220 | 210 | 220 | 230 | 220 | 220 | 210 | 210 | 210 | 220 | 200 |
| In-plane shear modulus after water | 6.4 | 6.5 | 6.5 | 6.4 | 6.3 | 6.6 | 6.7 | 6.7 | 6.7 | 6.6 | 6.4 | 6.5 | 6.3 | 6.0 |
| imbibition [GPa] | | | | | | | | | | | | | | |
| Tensile strength [MPa] | 1330 | 1340 | 1350 | 1360 | 1340 | 1350 | 1350 | 1420 | 1450 | 1450 | 1430 | 1320 | 1340 | 1310 |
| Impregnation property | Good | Good | Good | Good | Good | Good | Good | Good | Good | Good | Good | Good | Good | Bad |

Examples 50 to 58 and Comparative Example 9 are as follows (including Table 8).

### (28) Raw Materials for Thermosetting Epoxy Resin Compositions

Raw materials used to obtain thermosetting epoxy resin compositions of the examples are same as the raw materials for thermosetting epoxy resin compositions described in the above subsection (1).

### (29) Production of Glass Fibers

The glass fibers [I] to [VII] were produced according to the following production methods.

### <Glass Fiber [I]>

A glass fiber woven fabric KS2700 (manufactured by Nitto Boseki Co., Ltd.) was used.

### <Glass Fiber [II]>

A glass fiber woven fabric KS2700 (manufactured by Nitto Boseki Co., Ltd.) was immersed in a methanol solution (1% by mass) of a coupling agent KBM-403 (3-glycidoxypropyltrimethoxysilane, manufactured by Shin-Etsu Chemical Co., Ltd.) for 7 hours and then dried in a hot air oven at 110° C. for 5 hours to remove the solvent and provide glass fibers [II] having oxirane groups on the surface.

### <Glass Fiber [III]>

Glass fibers [III] having amino groups on the surface were produced under the same conditions as those for the glass fibers [II], except that KBM-903 (3-aminopropyltrimethoxysilane, manufactured by Shin-Etsu Chemical Co., Ltd.) was used as the coupling agent.

### <Glass Fiber [IV]>

Glass fibers [IV] having thiol groups on the surface were produced under the same conditions as those for the glass fibers [II], except that KBM-803 (3-mercaptopropyltrimethoxysilane, manufactured by Shin-Etsu Chemical Co., Ltd.) was used as the coupling agent.

### <Glass Fiber [V]>

Glass fibers [V] having carboxy groups on the surface were produced under the same conditions as those for the glass fibers [II], except that X-12-967C (3-(trimethoxysilyl)propylsuccinic anhydride, manufactured by Shin-Etsu Chemical Co., Ltd.) was used as the coupling agent.

### <Glass Fiber [VI]>

Glass fibers [VI] having vinyl groups on the surface were produced under the same conditions as those for the glass fibers [II], except that KBM-1003 (vinyltrimethoxysilane, manufactured by Shin-Etsu Chemical Co., Ltd.) was used as the coupling agent.

### <Glass Fiber [VII]>

Glass fibers [VII] having methyl groups on the surface were produced under the same conditions as those for the glass fibers [II], except that methyltrimethoxysilane (manufactured by Kanto Chemical Co., Inc.) was used as the coupling agent.

### (30) Preparation of Thermosetting Epoxy Resin Compositions

According to each of the compositions (in mass ratio) shown in Table 6, epoxy resin compositions were prepared in the same manner as in the above subsection (5) “Preparation of thermosetting epoxy resin compositions”.

### (31) Production of Fiber-Reinforced Composite Materials

The glass fibers produced as described in the above subsection (29) “Production of glass fibers” and the thermosetting epoxy resin compositions prepared as described in the above subsection (30) “Preparation of thermosetting epoxy resin compositions” were used to produce fiber-reinforced composite materials, similarly to the above subsection (16) “Production of fiber-reinforced composite materials”.

(32) Measurement of In-Plane Shear Strength and Shear Modulus after Water Imbibition

The fiber-reinforced composite materials produced as described in the above subsection (31) “Production of fiber-reinforced composite materials” were analyzed to determine the in-plane shear strength and the in-plane shear modulus after water imbibition, similarly to the above subsection (17) “Measurement of in-plane shear strength and shear modulus after water imbibition”.

### (33) Measurement of Tensile Strength

The fiber-reinforced composite materials produced as described in the above subsection (31) “Production of fiber-reinforced composite materials” were analyzed by performing the tensile test in accordance with JIS K 7164: 2005 to determine the tensile strength.

(34) Measurement of the Impregnating Property of Thermosetting Epoxy Resin Compositions into Reinforcing Fibers

The impregnating property during the resin injection process for the above subsection (31) “Production of fiber-reinforced composite materials” was evaluated similarly to the above subsection (18) “Measurement of the impregnating property of thermosetting epoxy resin compositions into reinforcing fibers”.

### Example 50

A thermosetting epoxy resin was prepared as described in the above subsection (30) “Preparation of thermosetting epoxy resin compositions” and then used as described in the above subsection (31) “Production of fiber-reinforced composite materials” to produce a fiber-reinforced composite material. The fiber-reinforced composite material had an in-plane shear strength of 170 MPa, which was excellent, and an in-plane shear modulus after water imbibition of 5.4 GPa, which was excellent, and a tensile strength of 230 MPa, which was acceptable. In addition, the impregnating property was evaluated as good.

### Example 51

The component [c] was changed from that used in Example 50 to a high-activity species. The fiber-reinforced composite material had an in-plane shear strength of 175 MPa, which was excellent, and an in-plane shear modulus after water imbibition of 5.5 GPa, which was excellent, and a tensile strength of 235 MPa, which was acceptable. In addition, the impregnating property was evaluated as excellent.

### Example 52

The component [c] was changed from that used in Example 50 to a low-activity species. The fiber-reinforced composite material had an in-plane shear strength of 170 MPa, which was excellent, and an in-plane shear modulus after water imbibition of 5.3 GPa, which was acceptable, and a tensile strength of 230 MPa, which was acceptable. In addition, the impregnating property was evaluated as good.

### Example 53

The reinforcing fiber in Example 51 was changed to another reinforcing fiber. The fiber-reinforced composite material had an in-plane shear strength of 170 MPa, which was excellent, and an in-plane shear modulus after water imbibition of 5.5 GPa, which was excellent, and a tensile strength of 245 MPa, which was excellent. In addition, the impregnating property was evaluated as good.

### Example 54

The reinforcing fiber in Example 51 was changed to another reinforcing fiber. The fiber-reinforced composite material had an in-plane shear strength of 180 MPa, which was particularly excellent, and an in-plane shear modulus after water imbibition of 5.6 GPa, which was particularly excellent, and a tensile strength of 245 MPa, which was excellent. In addition, the impregnating property was evaluated as good.

### Example 55

The reinforcing fiber in Example 51 was changed to another reinforcing fiber. The fiber-reinforced composite material had an in-plane shear strength of 175 MPa, which was excellent, and an in-plane shear modulus after water imbibition of 5.5 GPa, which was excellent, and a tensile strength of 245 MPa, which was excellent. In addition, the impregnating property was evaluated as good.

### Example 56

The reinforcing fiber in Example 51 was changed to another reinforcing fiber. The fiber-reinforced composite material had an in-plane shear strength of 170 MPa, which was excellent, and an in-plane shear modulus after water imbibition of 5.4 GPa, which was excellent, and a tensile strength of 245 MPa, which was excellent. In addition, the impregnating property was evaluated as good.

### Example 57

The reinforcing fiber in Example 51 was changed to another reinforcing fiber. The fiber-reinforced composite material had an in-plane shear strength of 165 MPa, which was acceptable, and an in-plane shear modulus after water imbibition of 5.3 GPa, which was acceptable, and a tensile strength of 250 MPa, which was excellent. In addition, the impregnating property was evaluated as fair.

### Example 58

The reinforcing fiber in Example 51 was changed to another reinforcing fiber. The fiber-reinforced composite material had an in-plane shear strength of 160 MPa, which was acceptable, and an in-plane shear modulus after water imbibition of 5.3 GPa, which was acceptable, and a tensile strength of 250 MPa, which was excellent. In addition, the impregnating property was evaluated as fair.

### Comparative Example 9

The component [c] was excluded from the composition of Example 50. The fiber-reinforced composite material had an in-plane shear strength of 155 MPa, which was poor, and an in-plane shear modulus after water imbibition of 5.1 GPa, which was poor, and a tensile strength of 220 MPa, which was poor. In addition, many voids were found in the fiber-reinforced composite material, and the impregnating property was evaluated as bad.

TABLE 8

| | | | Ex. | Ex. | Ex. | Ex. | Ex. | Ex. | Ex. | Ex. | Ex. | Comp |
|---|---|---|---|---|---|---|---|---|---|---|---|---|
| | | | 50 | 51 | 52 | 53 | 54 | 55 | 56 | 57 | 58 | Ex. 9 |
| Composition | [a] Epoxy resin | “jER” 828 | 100 | 100 | 100 | 100 | 100 | 100 | 100 | 100 | 100 | 100 |
| | [b] Isocyanate | “Lupranate” M20S | 71 | 71 | 71 | 71 | 71 | 71 | 71 | 71 | 71 | 71 |
| | curing agent | | | | | | | | | | | |
| | [c] Hydroxyl | Chlorophenyl isocyanate | 5 | | | | | | | | | |
| | group capping | Toluenesulfonyl isocyanate | | 5 | | 5 | 5 | 5 | 5 | 5 | 5 | |
| | agent | Chloroacetic anhydride | | | 5 | | | | | | | |
| | [d] Epoxy | “TBD”/dichloroacetic acid | 1 | 1 | 1 | 1 | 1 | 1 | 1 | 1 | 1 | 1 |
| | curing catalyst | | | | | | | | | | | |

| | | | | | | | | | | |
|---|---|---|---|---|---|---|---|---|---|---|
| Glass fiber | [I] | [I] | [I] | [II] | [III] | [IV | [V] | [VI] | [VII | [I] |
| Curing temperature [° C.] | 200 | 200 | 205 | 200 | 200 | 200 | 200 | 200 | 200 | 220 |
| In-plane shear strength [MPa] | 170 | 175 | 170 | 170 | 180 | 175 | 170 | 165 | 160 | 155 |
| In-plane shear modulus after water imbibition [GPa] | 5.4 | 5.5 | 5.3 | 5.5 | 5.6 | 5.5 | 5.4 | 5.3 | 5.3 | 5.1 |
| Tensile strength [MPa] | 230 | 235 | 230 | 245 | 245 | 245 | 245 | 250 | 250 | 220 |
| Impregnation property | Good | Good | Good | Good | Good | Good | Good | Fair | Fair | Bad |

Examples 59 and 60 are as follows (including Table 9).

### (35) Raw Materials for Thermosetting Epoxy Resin Compositions

Raw materials used to obtain thermosetting epoxy resin compositions of the examples are same as the raw materials for thermosetting epoxy resin compositions described in the above subsection (1).

### (36) Measurement of the Viscosity of the Main Agent Solutions and Mixed Solutions for Thermosetting Epoxy Resin Compositions

The complex viscosity η* of the main agent solution and mixed solution for each thermosetting epoxy resin composition prepared as described below at 25° C. was measured using a dynamic viscoelasticity-measuring apparatus (ARES: manufactured by TA instruments, Inc.) and parallel plates with a diameter of 40 mm under measurement conditions of 1-Hz frequency and 1-mm gap.

### Example 59

According to each of the compositions (in mass ratio) shown in Table 9, a component [a] and a component [c] were combined and mixed to homogeneity to prepare a main agent solution for a thermosetting epoxy resin composition. According to each of the compositions (in mass ratio) shown in Table 9, a component [b] and a component [d] were also combined, after which the dissolution of these components was confirmed with a phase contrast microscope, to prepare a curing agent solution for a thermosetting epoxy resin composition. Furthermore, the main agent solution and the curing agent solution were combined to prepare a mixed solution for a thermosetting epoxy resin composition. The viscosity of the main agent solution at 25° C. was 490 Pa·s, and the viscosity of the main agent at 25° C. was found to increase to 640 Pa·s, a 31% increase, when the main agent solution was stored at 25° C. for 30 days. In addition, the viscosity of the mixed solution at 25° C. was 4 Pa·s.

### Example 60

According to each of the compositions (in mass ratio) shown in Table 9, a component [a] and a component [d] were combined, after which the dissolution of these components was confirmed with a phase contrast microscope, to prepare a main agent solution for a thermosetting epoxy resin composition. According to each of the compositions (in mass ratio) shown in Table 9, a component [b] and a component [c] were also combined and mixed to homogeneity to prepare a curing agent solution for a thermosetting epoxy resin composition. Furthermore, the main agent solution and the curing agent solution were combined to prepare a mixed solution for a thermosetting epoxy resin composition. The viscosity of the main agent solution at 25° C. was 140 Pa·s, and the viscosity of the main agent at 25° C. was found to increase to 150 Pa·s, a 7% increase, when the main agent solution was stored at 25° C. for 30 days. In addition, the viscosity of the mixed solution at 25° C. was 5 Pa·s.

TABLE 9

| | | | Ex. 59 | Ex. 60 |
|---|---|---|---|---|
| Composition | [a] Epoxy resin | “jER” 828 | 100 | 100 |
| | [b] Isocyanate curing agent | “Lupranate” M20S | 71 | 71 |
| | [c] Hydroxyl group capping agent | Toluenesulfonyl isocyanate | 5 | 5 |
| | [d] Epoxy curing catalyst | “TBD”/dichloroacetic acid | 1 | 1 |
| Combination of two solutions | Main agent solution | | [a] + [c] | [a] + [d] |
| | Curing agent solution | | [b] + [d] | [b] + [c] |
| Viscosity at 25° C. [Pa · s] | Main agent solution | Immediately after preparation | 490 | 140 |
| | | After 30 days of storage at 25° C. | 640 | 150 |
| | Mixed solution | Immediately after preparation | 4 | 5 |

### INDUSTRIAL APPLICABILITY

The thermosetting epoxy resin compositions of the invention can be used as molding materials with high productivity and excellent performance in a wide range of fields and applications, such as transportation and general industry because the thermosetting epoxy resin compositions have achieved both improved pot life and fast curability at low temperatures and because both high heat wet resistance and excellent toughness are achieved in molded articles prepared by thermally curing the resin compositions. The thermosetting epoxy resin compositions make great contributions to, particularly, increase of production and improvement of performance of fiber-reinforced composite materials, which promotes application of fiber-reinforced composite materials to various industrial materials as well as to structural materials for automobiles or aircrafts, and are potentially expected to contribute to reduction of greenhouse gas emission due to the weight reduction of these materials and the resulting improvement of energy saving performance.

1. A thermosetting epoxy resin composition comprising the following components [a], [b], [c], and [d], wherein the stoichiometric ratio of [b] to [a] is in the range from 0.5 to 2.0:
[a] an epoxy resin;
[b] an isocyanate curing agent;
[c] a hydroxyl group capping agent;
[d] an epoxy curing catalyst.

2. The thermosetting epoxy resin composition according to claim 1, wherein the peak temperature Tc of the exothermic reaction between the component [c] and a hydroxyl group is 15° C. or more lower than the peak temperature Tb of the exothermic reaction between the component [b] and a hydroxyl group
(Tc is the peak temperature of the exothermic curve obtained by differential scanning calorimetry performed at a temperature ramp rate of 10° C./min on a mixture of 1-phenoxy-2-propanol and the component [c] in a mass ratio of 10:1; Tb is the peak temperature of the exothermic curve obtained by differential scanning calorimetry performed at a temperature ramp rate of 10° C./min on a mixture of 1-phenoxy-2-propanol and the component [b] in a mass ratio of 10:1).

3. The thermosetting epoxy resin composition according to claim 1, wherein the component [c] is at least one compound selected from the group consisting of the following compounds [I] to [VI]:
[I] a compound that contains at least one isocyanate group in the molecule;
[II] a compound that contains at least one carbodiimide group in the molecule;
[III] a compound that contains at least one acid anhydride structure in the molecule;
[IV] a compound that contains at least one orthoester structure in the molecule;
[V] a compound that contains at least one alkoxysilane structure in the molecule;
[VI] a compound that contains at least one oxazolidine structure in the molecule.

4. The thermosetting epoxy resin composition according to claim 1, wherein the component [c] is at least one compound selected from the group consisting of the following compounds [I] to [III]:
[I] a compound that contains at least one isocyanate group in the molecule;
[II] a compound that contains at least one carbodiimide group in the molecule;
[III] a compound that contains at least one acid anhydride structure in the molecule.

5. The thermosetting epoxy resin composition according to claim 1, wherein the component [c] is a compound having one isocyanate group.

6. The thermosetting epoxy resin composition according to claim 1, wherein the component [d] is a base and/or an acid-base complex.

7. The thermosetting epoxy resin composition according to claim 6, wherein the acid-base complex is an onium halide complex.

8. The thermosetting epoxy resin composition according to claim 7, wherein the onium halide complex is a quaternary ammonium halide and/or a quaternary phosphonium halide.

9. The thermosetting epoxy resin composition according to claim 6, wherein the acid-base complex is an inorganic salt.

10. A molded article prepared by thermally curing the thermosetting epoxy resin composition according to claim 1.

11. A fiber-reinforced composite material comprising the molded article according to claim 10 and a reinforcing fiber.

12-20. (canceled)

21. A molding material for fiber-reinforced composite material, comprising the thermosetting epoxy resin composition according to claim 1 and a reinforcing fiber.

22-30. (canceled)

31. A fiber-reinforced composite material prepared by thermally curing the molding material for fiber-reinforced composite material according to claim 21.

32. A method of producing a fiber-reinforced composite material, comprising impregnating reinforcing fibers with the thermosetting epoxy resin according to claim 1 and then curing the thermosetting epoxy resin by heat.

33. A method of producing a fiber-reinforced composite material, comprising placing a woven fabric composed primarily of reinforcing fibers into a mold, injecting the thermosetting epoxy resin composition according to claim 1 into the mold for impregnation, and then curing the thermosetting epoxy resin composition by heat.

34. The method of producing a fiber-reinforced composite material according to claim 32, wherein the thermosetting epoxy resin composition is made by blending a main agent solution comprising the components [a] and [c] with a curing agent solution comprising the components [b] and [d].

35. The method of producing a fiber-reinforced composite material according to claim 32, wherein the thermosetting epoxy resin composition is made by blending a main agent solution comprising the components [a] and [d] with a curing agent solution comprising the components [b] and [c].

36-44. (canceled)
